(19) United States
(12) Patent Application Publication
(10) Pub. No.: US 2026/0140623 A1
(43) Pub. Date: May 21, 2026

(54) STORAGE DEVICE EFFICIENTLY PERFORMING COMPRESSION OPERATIONS AND OPERATING METHOD OF THE SAME

(71) Applicant: SK hynix Inc., Icheon-si (KR)

(72) Inventor: Nam Hyun YUN, Icheon-si (KR)

(21) Appl. No.: 19/170,791

(22) Filed: Apr. 4, 2025

(30) Foreign Application Priority Data
Nov. 21, 2024 (KR) 10-2024-0167057

(51) Int. Cl. G06F 3/06

(52) U.S. Cl. CPC G06F 3/0608; G06F 3/0655; G06F 3/0679

(57) ABSTRACT

A storage device comprises a memory device with a storage region, a compression operation unit that generates compression data by performing a first compression operation on write data, and a control operation unit that divides the storage region into multiple storage spaces, selects N selection storage spaces, controls the compression operation unit, and stores first and second data in (N-K+1) selection storage spaces when the sum of the size of the first data, which is a compressed portion of the write data at a first timing, and the size of the second data, which is an uncompressed portion of the write data at the first timing, is equal to or smaller than a storage size corresponding to (N-K+1) selection storage spaces at the first timing when the execution rate of the first compression operation reaches a first execution rate.

### CROSS-REFERENCE TO RELATED APPLICATION

This application claims priority under 35 U.S.C. § 119(a) to Korean Patent Application No. 10-2024-0167057, filed in the Korean Intellectual Property Office on Nov. 21, 2024, the entire contents of which are incorporated herein by reference.

### BACKGROUND

### 1. Field

Exemplary embodiments relate to a storage device, and particularly, to a storage device efficiently performing compression operations and an operating method of the storage device.

### 2. Discussion of the Related Art

Memory systems may refer to storage devices using semiconductor materials such as silicon (Si), germanium (Ge), gallium arsenide (GaAs), indium phosphide (InP), or the like. The storage devices are generally classified into volatile memory devices and nonvolatile memory devices. A volatile memory device is configured to lose data stored therein when power supply is interrupted. Representative examples of volatile memory devices include a static RAM (SRAM), a dynamic RAM (DRAM), a synchronous DRAM (SDRAM), etc. A nonvolatile memory device is configured to retain data stored therein even when power supply is interrupted. Representative examples of nonvolatile memory devices include a read only memory (ROM), a programmable ROM (PROM), an electrically programmable ROM (EPROM), an electrically erasable programmable ROM (EEPROM), a flash memory, a phase-change random access memory (PRAM), a magnetic RAM (MRAM), a resistive RAM (RRAM), a ferroelectric RAM (FRAM), etc. Flash memories may include a NOR-type flash memory and a NAND-type flash memory.

A storage device may further include a controller (i.e., a memory controller) for controlling a memory (for example, a volatile memory/a nonvolatile memory), and such a controller may receive a command from an external device (i.e., a host), and perform data read, write, and erase operations on a memory included in a storage device based on the received command or control the operations of the storage device.

On the other hand, the size of memory capacity required in a computing system continues to increase. In particular, in the case of a volatile memory having a higher price per capacity than a nonvolatile memory, increasing the size of memory capacity is more difficult.

Therefore, a method for compressing and storing data stored in a volatile memory included in the storage device has been proposed.

### SUMMARY

Various embodiments are directed to providing a storage device capable of retaining write data in an internal memory device by compressing the write data and an operating method of the storage device.

The problems to be solved by the present disclosure are not limited to the above-mentioned problems, and the other problems not mentioned here will be clearly understood from the following description by those skilled in the art.

An aspect of an embodiment in the disclosure, a storage device may include: a memory device comprising a storage region; a compression operation unit configured to generate compression data by performing a first compression operation on write data; and a control operation unit configured to divide the storage region into a plurality of storage spaces, configured to select N selection storage spaces from among the plurality of storage spaces, configured to control the compression operation unit, and configured to store a first data and a second data in (N−K+1) selection storage spaces when a first sum size of a size of the first data, which is a portion of the write data on which compression has been performed at a first timing, and a size of the second data, which is a portion of the write data on which compression has not been performed at the first timing, is equal to or smaller than a storage size corresponding to (N−K+1) selection storage spaces at the first timing when an execution rate of the first compression operation reaches a first execution rate. the N may be a natural number equal to or greater than 1, and K may be a natural number that is equal to or smaller than N and equal to or greater than 1.

An aspect of an embodiment in the disclosure, an operating method of a storage device comprising a memory device comprising a storage region, the operating method may include: dividing the storage region into a plurality of storage spaces; selecting N selection storage spaces, among the plurality of storage spaces, based on a size of write data; performing a first compression operation to generate compression data from compressing the write data; stopping the first compression operation when a first sum size of a size of a first data from among the write data on which compression has been performed at a first timing, and a size of a second data from among the write data on which compression has not been performed at the first timing, is equal to or smaller than a storage size corresponding to (N−K+1) selection storage spaces at the first timing at which time an execution rate of the first compression operation reaches a first execution rate; and storing the first and second data in the (N−K+1) selection storage spaces when the first compression operation is stopped at the first timing. N may be a natural number equal to or greater than 1, and K may be a natural number that is equal to or smaller than N and equal to or greater than 1.

According to the present technology, when write data are compressed and stored in the memory device, whether to stop a compression operation may be selected by checking the state of a compression operation in real time. That is, according to the present technology, the remaining data that have not been compressed, along with some data of write data that have already been compressed, can be stored in the memory device without any change by stopping a compression operation depending on whether the compression operation is efficient.

Accordingly, the time consumed for a compression operation can be minimized, and the size of the space that is assigned to store write data in a memory device can also be minimized.

### BRIEF DESCRIPTION OF THE DRAWINGS

FIGS. 1A to 1D are diagrams for describing a data processing system including a storage device according to an embodiment of the present disclosure.

FIGS. 2A to 2E are diagrams illustrating an example of an operation of compressing and storing, by a storage device, write data in an internal memory device according to embodiments of the present disclosure.

FIGS. 3A to 3F are diagrams for describing other examples of compressing and storing, by a storage device, write data in an internal memory device according to embodiments of the present disclosure.

FIGS. 4A to 4C are diagrams for describing still other examples of compressing and storing, by a storage device, write data in an internal memory device according to embodiments of the present disclosure.

FIGS. 5A to 5C are flowcharts for describing sequences of operations of compressing and storing, by a storage device, write data in an internal memory device according to embodiments of the present disclosure.

### DETAILED DESCRIPTION

Various embodiments of the present disclosure are described below with reference to the accompanying drawings. Elements and features of the disclosure, however, may be configured or arranged differently to form other embodiments, which may be variations of any of the disclosed embodiments.

In this disclosure, references to various features (e.g., elements, structures, modules, components, steps, operations, characteristics, etc.) included in “one embodiment,” “example embodiment,” “an embodiment,” “another embodiment,” “some embodiments,” “various embodiments,” “other embodiments,” “alternative embodiment,” and the like are intended to mean that any such features are included in one or more embodiments of the present disclosure, but may or may not necessarily be combined in the same embodiments.

In this disclosure, the terms “comprise,” “comprising,” “include,” and “including” are open-ended. As used in the appended claims, these terms specify the presence of the stated elements and do not preclude the presence or addition of one or more other elements. The terms in a claim do not foreclose the apparatus from including additional components (e.g., an interface unit, circuitry, etc.).

In this disclosure, various units, circuits, or other components may be described or claimed as “configured to” perform a task or tasks. In such contexts, “configured to” is used to connote structure by indicating that the blocks/units/circuits/components include structure (e.g., circuitry) that performs one or more tasks during operation. As such, the block/unit/circuit/component can be said to be configured to perform the task even when the specified block/unit/circuit/component is not currently operational (e.g., is not turned on nor activated). The block/unit/circuit/component used with the “configured to” language includes hardware, such as for example, circuits, memory storing program instructions executable to implement the operation, etc. Additionally, “configured to” can include a generic structure (e.g., generic circuitry) that is manipulated by software and/or firmware (e.g., an FPGA or a general-purpose processor executing software) to operate in a manner that is capable of performing the task(s) at issue. “Configured to” may also include adapting a manufacturing process (e.g., a semiconductor fabrication facility) to fabricate devices (e.g., integrated circuits) that implement or perform one or more tasks.

As used in the disclosure, the term ‘circuitry’ or ‘logic’ refers to all of the following: (a) hardware-only circuit implementations (such as implementations in only analog and/or digital circuitry) and (b) combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions and (c) circuits, such as a microprocessor(s) or a portion of a microprocessor(s), that require software or firmware for operation, even if the software or firmware is not physically present. This definition of ‘circuitry’ or ‘logic’ applies to all uses of this term in this application, including in any claims. As a further example, as used in this application, the term “circuitry” or “logic” also covers an implementation of merely a processor (or multiple processors) or a portion of a processor and its (or their) accompanying software and/or firmware. The term “circuitry” or “logic” also covers, for example, and if applicable to a particular claim element, an integrated circuit for a storage device.

As used herein, the terms “first,” “second,” “third,” and so on are used as labels for nouns that the terms precede, and do not imply any type of ordering (e.g., spatial, temporal, logical, etc.). The terms “first” and “second” do not necessarily imply that the first value must be written before the second value. Further, although the terms may be used herein to identify various elements, these elements are not limited by these terms. These terms are used to distinguish one element from another element that otherwise have the same or similar names. For example, a first circuitry may be distinguished from a second circuitry.

Further, the term “based on” is used to describe one or more factors that affect a determination. This term does not foreclose additional factors that may affect a determination. That is, a determination may be solely based on those factors or based, at least in part, on those factors. For example, the phrase “determine A based on B.” While in this case, B is a factor that affects the determination of A, such a phrase does not foreclose the determination of A from also being based on C. In other instances, A may be determined based solely on B.

Herein, an item of data, a data item, a data entry or an entry of data may be a sequence of bits. For example, the data item may include the contents of a file, a portion of the file, a page in memory, an object in an object-oriented program, a digital message, a digital scanned image, a part of a video or audio signal, metadata or any other entity which can be represented by a sequence of bits. According to an embodiment, the data item may include a discrete object. According to another embodiment, the data item may include a unit of information within a transmission packet between two different components.

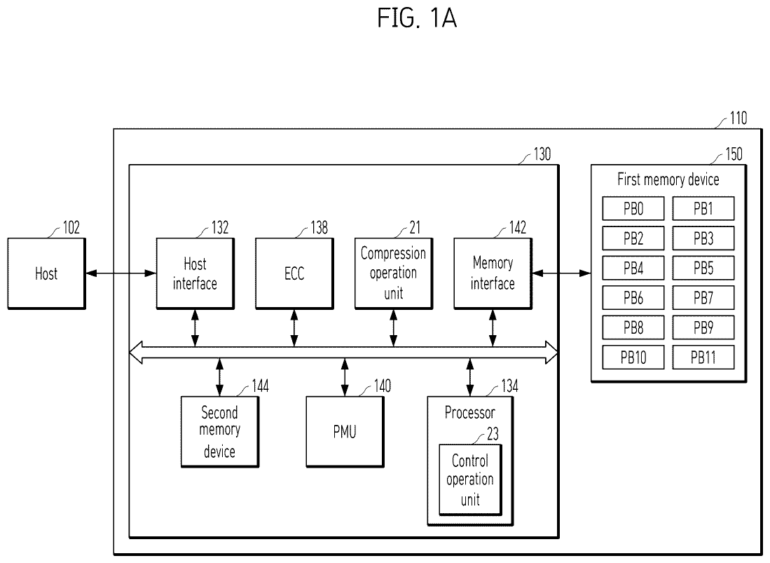

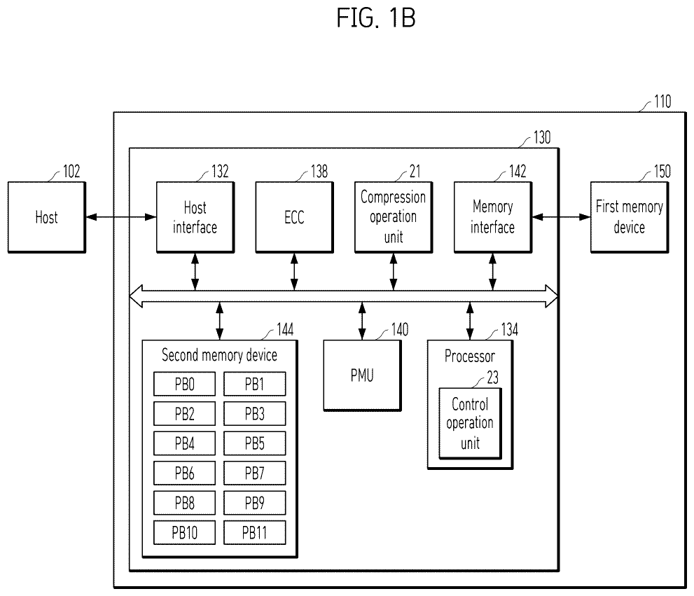

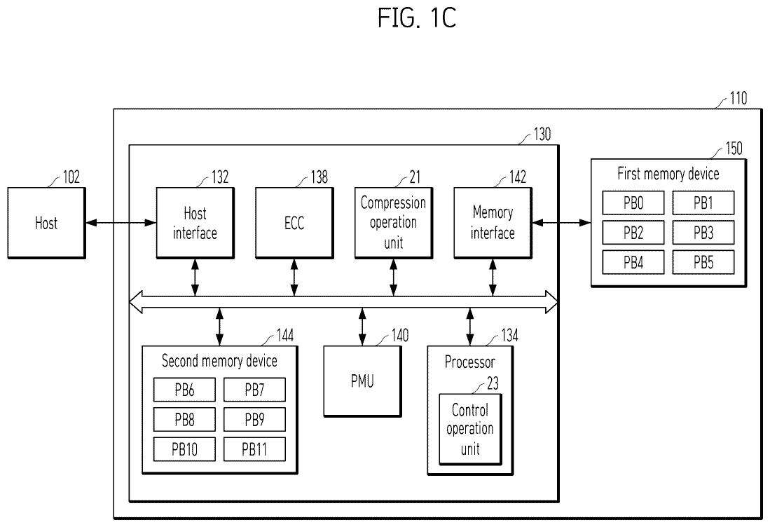

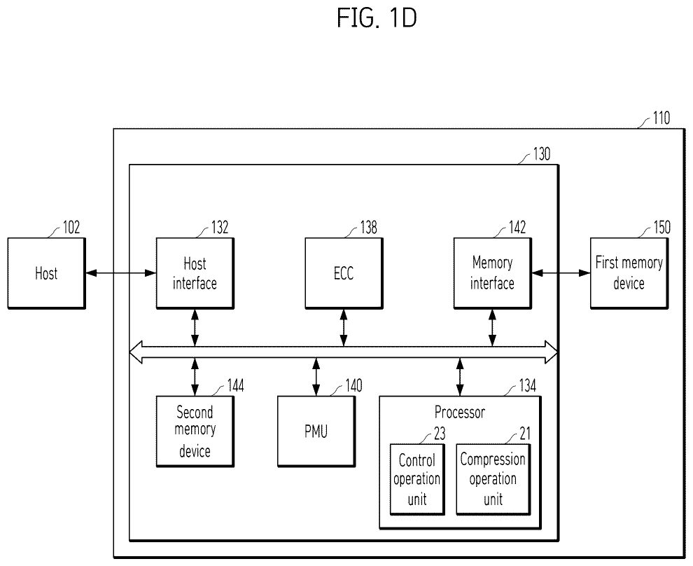

FIGS. 1A to 1D are diagrams for describing a data processing system including a storage device according to an embodiment of the present disclosure.

Referring to FIGS. 1A to 1D, a data processing system may include a host 102 engaged or coupled with a memory system (i.e., a storage device 110). For example, the host 102 and the storage device 110 can be coupled to each other via a data bus, a host cable and the like to perform data communication.

The storage device 110 may include a first memory device 150 and a controller 130. The first memory device 150 and the controller 130 in the storage device 110 may be considered components or elements physically separated from each other. The first memory device 150 and the controller 130 may be connected via at least one data path. For example, the data path may include a channel and/or a way.

According to an embodiment, the first memory device 150 and the controller 130 may be components or elements that are functionally divided. Further, according to an embodiment, The first memory device 150 and the controller 130 may be implemented with a single chip or a plurality of chips. The controller 130 may perform a data input/output operation in response to a request input from the external device. For example, when the controller 130 performs a read operation in response to a read request input from an external device, data stored in a plurality of non-volatile memory cells included in the first memory device 150 is transferred to the controller 130.

Furthermore, the controller 130 may include a second memory device 144 therein.

That is, the controller 130 may control the first memory device 150, which is external to the controller 130 or the second memory device 144 located in the controller 130, in order to perform an operation that corresponds to a request from the host 102 (e.g., read, program/write, or erase operations). Furthermore, the controller 130 may control the first memory device 150 or the second memory device 144 in order to independently operate the storage device 110 regardless of or in the absence of a request from the host 102.

According to an embodiment, the first and second memory devices 150 and 144 may each be volatile memories or nonvolatile memories.

Furthermore, the controller 130 and the first memory device 150 may be components that are physically divided. The first memory device 150 and the controller 130 may be connected by at least one data path. For example, the data path may consist of a channel and/or a way.

Furthermore, the second memory device 144 included in the controller 130 may be connected to other components 132, 134, 138, 140, 142, and 21 within the controller 130 through a data bus.

Specifically, the storage device 110 according to an embodiment of the present disclosure may generate compression data by compressing write data, and may manage the generated compression data in the first memory device 150 or the second memory device 144.

According to an embodiment, managing, by the storage device 110, compression data in the first memory device 150 may mean that an access operation for the compression data is performed only in the first memory device 150 when the compression data is stored in the first memory device 150. In such a case, the storage device 110 may use the second memory device 144 included in the controller 130 to store data necessary for control when the controller 130 controls the first memory device 150 in response to a request from the host 102.

According to another embodiment, managing, by the storage device 110, compression data in the second memory device 144 may mean that an access operation for the compression data is performed only in the second memory device 144 when the compression data is stored in the second memory device 144. In such a case, the storage device 110 may merely store the compression data in the first memory device 150 for backup purposes, and the access operation for the compression data may be fully performed through the second memory device 144. That is, the storage device 110 may use the first memory device 150 in order to manage data other than the compression data. For reference, an operation of storing compression data in the first memory device 150 for backup purposes is an operation that may be selected by a designer.

According to still another embodiment, managing, by the storage device 110, compression data in both the first memory device 150 and the second memory device 144 may mean that the compression data are distributed and stored in the first memory device 150 and the second memory device 144.

According to an embodiment, write data may be data for which a write request has been made from the host 102 to the storage device 110.

According to another embodiment, write data may be data that are generated within the controller 130 for use in an operation of the storage device 110.

The controller 130 according to an embodiment of the present disclosure may include a host interface 132, a processor 134, a power management unit (PMU) 140, a memory interface 142, and an error correction unit (error correction code (ECC)) 138 along with the second memory device 144.

The host 102 and the memory system 110 each may include a controller or an interface for transmitting and receiving signals, data, and the like, in accordance with one or more predetermined protocols. For example, the host interface 132 in the memory system 110 may include an apparatus capable of transmitting signals, data, and the like to the host 102 or receiving signals, data, and the like from the host 102.

The host interface 132 included in the controller 130 may receive signals, commands (or requests), and/or data input from the host 102 via a bus. For example, the host 102 and the memory system 110 may use a predetermined set of rules or procedures for data communication or a preset interface to transmit and receive data therebetween.

Examples of communication standards or interfaces used to transmit/receive data may include various form factors such as 2.5-inch form factor, 1.8-inch form factor, MO-297, MO-300, M.2, and EDSFF (Enterprise and Data Center SSD Form Factor) and various communication standards or interfaces such as USB (Universal Serial Bus), MMC (Multi-Media Card), PATA (Parallel Advanced Technology Attachment), SCSI (Small Computer System Interface), ESDI (Enhanced Small Disk Interface), IDE (Integrated Drive Electronics), PCIe (Peripheral Component Interconnect Express), SAS (Serial-attached SCSI), SATA (Serial Advanced Technology Attachment), and MIPI (Mobile Industry Processor Interface).

According to an embodiment, the host interface 132 is a type of layer for exchanging data with the host 102 and is implemented with, or driven by, firmware called a host interface layer (HIL). According to an embodiment, the host interface 132 can include a command queue.

The Integrated Drive Electronics (IDE) or Advanced Technology Attachment (ATA) may be used as one of the interfaces for transmitting and receiving data and, for example, may use a cable including 40 wires connected in parallel to support data transmission and data reception between the host 102 and the memory system 110. When a plurality of memory systems 110 are connected to a single host 102, the plurality of memory systems 110 may be divided into a master and a slave by using a position or a dip switch to which the plurality of memory systems 110 are connected. The memory system 110 set as the master may be used as a main memory device. The IDE (ATA) may include, for example, Fast-ATA, ATAPI, or Enhanced IDE (EIDE).

A Serial Advanced Technology Attachment (SATA) interface is a type of serial data communication interface that is compatible with various ATA standards of parallel data communication interfaces that are used by Integrated Drive Electronics (IDE) devices. The 40 wires in the IDE interface can be reduced to six wires in the SATA interface. For example, 40 parallel signals for the IDE can be converted into 6 serial signals for the SATA interface. The SATA interface has been widely used because of its faster data transmission and reception rate and its lower resource consumption in the host 102 for the data transmission and reception. The SATA interface may connect up to 30 external devices to a single transceiver included in the host 102. In addition, the SATA interface can support hot plugging that allows an external device to be attached to or detached from the host 102, even while data communication between the host 102 and another device is being executed. Thus, the memory system 110 can be connected or disconnected as an additional device, like a device supported by a universal serial bus (USB), even when the host 102 is powered on. For example, in the host 102 having an eSATA port, the memory system 110 may be freely attached to or detached from the host 102 like an external hard disk.

Small Computer System Interface (SCSI) is a type of serial data communication interface used for connecting a computer or a server with other peripheral devices. The SCSI can provide a high transmission speed, as compared with other interfaces such as IDE and SATA. In the SCSI, the host 102 and at least one peripheral device (e.g., memory system 110) are connected in series, but data transmission and reception between the host 102 and each peripheral device may be performed through parallel data communication. In the SCSI, it is easy to connect or disconnect a device such as the memory system 110 to or from the host 102. The SCSI can support connections of 15 other devices to a single transceiver included in host 102.

Serial Attached SCSI (SAS) can be understood as a serial data communication version of the SCSI. In the SAS, the host 102 and a plurality of peripheral devices are connected in series, and data transmission and reception between the host 102 and each peripheral device may be performed in a serial data communication scheme. The SAS can support connection between the host 102 and the peripheral device through a serial cable instead of a parallel cable, to easily manage equipment using the SAS and enhance or improve operational reliability and communication performance. The SAS may support connections of eight external devices to a single transceiver included in the host 102.

The Non-Volatile Memory Express (NVMe) is a type of interface based at least on a Peripheral Component Interconnect Express (PCIe) designed to increase performance and design flexibility of the host 102, servers, computing devices, and the like equipped with the non-volatile memory system 110. The PCIe can use a slot or a specific cable for connecting a computing device (e.g., host 102) and a peripheral device (e.g., memory system 110). For example, the PCIe can use a plurality of pins (e.g., 18 pins, 32 pins, 49 pins, or 82 pins) and at least one wire (e.g., ×1, ×4, ×8, or ×16) to achieve high speed data communication over several hundred MB per second (e.g., 250 MB/s, 500 MB/s, 984.6250 MB/s, or 1969 MB/s). According to an embodiment, the PCIe scheme may achieve bandwidths of tens to hundreds of gigabits per second. The NVMe can support an operation speed of the non-volatile memory system 110, such as an SSD, that is faster than a hard disk.

According to an embodiment, the host 102 and the memory system 110 may be connected through a universal serial bus (USB). The Universal Serial Bus (USB) is a type of scalable, hot-pluggable plug-and-play serial interface that can provide cost-effective standard connectivity between the host 102 and peripheral devices such as a keyboard, a mouse, a joystick, a printer, a scanner, a storage device, a modem, a video camera, and the like. A plurality of peripheral devices such as the memory system 110 may be coupled to a single transceiver included in the host 102.

The error correction unit 138 may check and correct errors in data transmitted between the controller 130 and the first memory device 150. The error correction unit 138 may be implemented as a separate module, circuit or firmware in the controller 130, but can also be implemented in the first memory device 150 according to an embodiment.

The error correction unit 138 may include all circuits, modules, systems, and/or devices for performing error correction operations based on at least one error code.

The error correction unit 138 can correct error bits of data read from the first memory device 150, and may include an error correction code (ECC) encoder and an ECC decoder. The ECC encoder may perform error correction encoding of data to be programmed in the first memory device 150 to generate encoded data into which a parity bit is added, and store the encoded data in the first memory device 150. The ECC decoder can detect and correct error bits contained in the data read from the first memory device 150 when the controller 130 reads the data stored in the first memory device 150. For example, after performing error correction decoding on the data read from the first memory device 150, the error correction unit 138 determines whether the error correction decoding has succeeded or not, and outputs an instruction signal, e.g., a correction success signal or a correction fail signal, based on a result of the error correction decoding. The error correction unit 138 may use a parity bit, which has been generated during the ECC encoding process for the data stored in the first memory device 150, in order to correct the error bits of the read data entries. When the number of the error bits is greater than or equal to the number of correctable error bits, the error correction unit 138 may not correct the error bits and instead may output a correction fail signal indicating failure in correcting the error bits.

According to an embodiment, the error correction unit 138 may perform an error correction operation based on a coded modulation such as a low density parity check (LDPC) code, a Bose-Chaudhuri-Hocquenghem (BCH) code, a turbo code, a Reed-Solomon (RS) code, a convolution code, a recursive systematic code (RSC), a trellis-coded modulation (TCM), a Block coded modulation (BCM), or the like.

An operation performed by the ECC decoder, that is, an operation of detecting and correcting errors included in read data, may be an operation distinct from the above-described read retry operation. According to an embodiment, the controller 130 may perform an error correction decoding operation through the ECC decoder when errors equal to or greater than a reference value occur even though the read retry operation, which is a repeated read operation, has been performed using the plurality of read retry levels.

The power management unit (PMU) 140 may control electrical power provided to the controller 130. The PMU 140 may monitor the electrical power supplied to the memory system 110, e.g., a voltage supplied to the controller 130, and provide the electrical power to components included in the controller 130. The PMU 140 may not only detect power-on or power-off, but also generate a trigger signal to enable the memory system 110 to urgently back up a current state when the electrical power supplied to the memory system 110 is unstable. According to an embodiment, the PMU 140 may include a device or a component capable of accumulating electrical power that may be used in an emergency.

The memory interface 142 may serve as an interface for handling commands and data transferred between the controller 130 and the first memory device 150, in order to allow the controller 130 to control the first memory device 150 in response to a command or a request input from the host 102. The memory interface 142 may generate a control signal for the first memory device 150 and may process data input to, or output from, the first memory device 150 under the control of the processor 134, such as when the first memory device 150 is a flash memory.

For example, when the first memory device 150 includes a NAND flash memory, the memory interface 142 includes a NAND flash controller (NFC). The memory interface 142 can provide an interface for handling commands and data between the controller 130 and the first memory device 150. In accordance with an embodiment, the memory interface 142 can be implemented through, or driven by, firmware called a Flash Interface Layer (FIL) for exchanging data with the first memory device 150.

According to an embodiment, the memory interface 142 may support an open NAND flash interface (ONFi), a toggle mode, or the like, for data input/output with the first memory device 150. For example, the ONFi may use a data path (e.g., a channel, a way, etc.) that includes at least one signal line capable of supporting bi-directional transmission and reception in a unit of 8-bit or 16-bit data. Data communication between the controller 130 and the first memory device 150 can be achieved through at least one interface regarding an asynchronous single data rate (SDR), a synchronous double data rate (DDR), a toggle double data rate (DDR), or the like.

The second memory device 144 may store data for the driving of the storage device 110 and the controller 130. That is, the second memory device 144 may store data that are necessary for the controller 130 to control the external first memory device 150 in response to a request from the host 102.

As in aforementioned embodiments, when the storage device 110 manages compression data in the first memory device 150, the storage device 110 may store data necessary to control the first memory device 150 in the second memory device 144.

When the storage device 110 manages compression data in the second memory device 144, the storage device 110 may store compression data in the second memory device 144 along with data that are necessary to control the first memory device 150.

The compression operation unit 21 may generate compression data by performing a compression operation on write data.

Write data may refer to original data that have not been compressed, for example, raw data. The compression data may refer to data that have been compressed to have a smaller size than the original data by performing a compression operation on write data.

Furthermore, the compression operation may refer to an operation using various compression algorithms, such as LZ4, LZ4HC, zStd, bzip2, xz, 7zip, PAQ, ZPAQ, and brotil. For example, a compression operation that supports a very fast compression operation speed, but has a low compression rate may be an operation using the LZ4 compression algorithm. A compression operation that supports a relatively slower operation speed and higher compression rate than the LZ4 compression algorithm may be an operation using the zStd compression algorithm. Furthermore, a compression algorithm that supports a relatively higher compression rate than the zStd compression algorithm, but has a very slow operation speed may be an operation using the 7zip compression algorithm. Thus, the compression operation is in a trade-off relationship between compression rate and the operation speed. That is, the speed of the compression operation is decreased if the compression rate is increased, whereas the compression rate is inevitably decreased if the speed of the compression operation is increased.

The compression operation unit 21 according to an embodiment of the present disclosure may select any one of various compression algorithms, such as LZ4, LZ4HC, zStd, bzip2, xz, 7zip, PAQ, ZPAQ, and brotil, under the control of a control operation unit 23 included in the processor 134, and may perform a compression operation by using the selected compression algorithm.

According to an embodiment, the compression operation unit 21 may generate compression data by performing a first compression operation on write data, and furthermore, the compression operation unit 21 may generate compression data by performing a second compression operation on write data. The first compression operation and the second compression operation may be operations using different compression algorithms. For example, the first compression operation may be an operation using the zStd compression algorithm. The second compression operation may be an operation using the LZ4 compression algorithm, which supports a lower compression rate and higher operation speed than the first compression operation.

Furthermore, the compression operation unit 21 may divide write data into a plurality of partial data, may arrange the order of the plurality of partial data by confirming the features of each of the plurality of divided partial data, and may perform a compression operation on the plurality of partial data in the order of arrangement.

According to an embodiment, write data may include feature information for confirming the features of each of a plurality of partial data included in the write data. The compression operation unit 21 may arrange the order of the plurality of partial data with reference to the feature information.

The processor 134 may control the overall operations of the memory system 110. For example, the processor 134 can control a program operation or a read operation of the first memory device 150 or the second memory device 144 in response to a write request or a read request entered from the host 102.

According to an embodiment, the processor 134 may execute firmware to control the program operation or the read operation in the memory system 110. Herein, the firmware may be referred to as a flash translation layer (FTL). According to an embodiment, the processor 134 may be implemented with a microprocessor, a central processing unit (CPU), or the like.

According to an embodiment, the memory system 110 may be implemented with at least one multi-core processor. A multi-core processor is a type of circuit or chip in which two or more cores, which are considered distinct processing regions, are integrated. For example, when a plurality of cores in the multi-core processor drive or execute a plurality of flash translation layers (FTLs) independently, a data input/output speed (or performance) of the memory system 110 may be improved. According to an embodiment, the data input/output (I/O) operations in the memory system 110 may be independently performed through different cores in the multi-core processor.

According to an embodiment, as illustrated in FIG. 1C, a compression operation unit 21 may be included in the controller 130 as a component that is fully divided from the processor 134 either in a hardware aspect or a software aspect. That is, an operation of the compression operation unit 21 may be controlled by a control operation unit 23 included in the processor 134, but may be performed in a form (parallel) that is fully independent of an operation of the processor.

According to another embodiment, as illustrated in FIG. 1D, a compression operation unit 21 may be a component included in the processor 134 either in a hardware aspect or a software aspect. That is, the processor 134 may include the compression operation unit 21 and a control operation unit 23. In such a case, a compression operation performed in the compression operation unit 21 and an operation of the processor 134 may be performed sequentially or alternately.

The control operation unit 23 included in the processor 134 may divide a storage region of the first memory device 150 or the second memory device 144 into a plurality of storage spaces PB<0:11> in order to store compression data.

For example, if the storage device 110 manages compression data in the first memory device 150, as illustrated in FIG. 1A, the control operation unit 23 may divide a storage region of only the first memory device 150 into a plurality of storage spaces PB<0:11>.

If the storage device 110 manages compression data in the second memory device 144, as illustrated in FIG. 1B, the control operation unit 23 may divide a storage region of the second memory device 144 into a plurality of storage spaces PB<0:11>.

If the storage device 110 manages compression data in both the first memory device 150 and the second memory device 144, as illustrated in FIG. 1C, the control operation unit 23 may divide storage regions of the first memory device 150 and the second memory device 144 into a plurality of storage spaces PB<0:5> and a plurality of storage spaces PB<6:11>, respectively.

In this case, the storage region divided into the plurality of storage spaces in the first memory device 150 or the second memory device 144 may be at least some of the storage regions out of the entire storage region of the device, respectively.

For example, as illustrated in FIG. 1A, if the storage device 110 manages compression data in the first memory device 150, the control operation unit 23 may divide at least some of the entire storage region of the first memory device 150 into the plurality of storage spaces PB<0:11>.

Furthermore, as illustrated in FIG. 1b, if the storage device 110 manages compression data in the second memory device 144, the control operation unit 23 may divide at least some of the entire storage region of the second memory device 144 into the plurality of storage spaces PB<0:11>.

Furthermore, as illustrated in FIG. 1C, if the storage device 110 manages compression data in both the first memory device 150 and the second memory device 144, the control operation unit 23 may divide at least some of the entire storage region of the first memory device 150 and at least some of the entire storage region of the second memory device 144 into the plurality of storage spaces PB<0:11>.

For reference, the drawings illustrate that the control operation unit 23 divides a storage region of the first memory device 150 and/or the second memory device 144 into the 12 storage spaces PB<0:11> in order to store compression data, but this is only one embodiment. In other embodiments, the control operation unit 23 may divide a storage region of the first memory device 150 or the second memory device 144 into a smaller or greater number of storage spaces than the 12 storage spaces.

Furthermore, the control operation unit 23 may manage data in at least one storage space unit in the first memory device 150 or the second memory device 144. For example, if the first memory device 150 or the second memory device 144 is a nonvolatile memory device, the control operation unit 23 may selectively apply any one of one page unit, one block unit, and one super block unit as a unit of storage space. As another example, if the first memory device 150 or the second memory device 144 is a volatile memory device, one storage space unit may be a preset to one data processing unit (i.e., the number of data pads*the size of a burst length).

Accordingly, dividing, by the control operation unit 23, the storage region of the first memory device 150 or the second memory device 144 into the plurality of storage spaces PB<0:11> may mean that the storage region of the first memory device 150 or the second memory device 144 is divided in units of data in sizes that may be accessed in one access to the first memory device 150 or the second memory device 144.

Furthermore, the control operation unit 23 may select N selection storage spaces, among the plurality of storage spaces PB<0:11>, in order to store compression data generated in the compression operation unit 21, where N is a natural number equal to or greater than 1. In this case, the control operation unit 23 may select N selection storage spaces from among the plurality of storage spaces PB<0:11> for storing one compression datum. Furthermore, the control operation unit 23 may determine the value of N differently with respect to each of a plurality of compression data. For example, the control operation unit 23 may determine the value of N based on the size of input write data.

More specifically, the control operation unit 23 may predict the size of compression data based on the size of the write data, and may determine the value of N on the basis of the predicted size. That is, the control operation unit 23 may determine how many storage spaces, from among the plurality of storage spaces PB<0:11>, will be selected as selection storage spaces for compressed data based on the size of the write data. The size of the write data and the value of N may be proportional to each other. The proportion of the size of the write data and the value of N may be vary, however, depending on the algorithm used in a compression operation or the features of write data.

For example, using the size of a first write data, the control operation unit 23 may predict the size of first compression data to be generated by the compression operation unit 21 from compressing the first write data as a size that requires three storage spaces. Accordingly, the control operation unit 23 may select three selection storage spaces PB<0:2> from among the plurality of storage spaces PB<0:11>.

As another example, when a second write data is greater in size than the first write data, using the size of the second write data, the control operation unit 23 may predict the size of second compression data, which is generated by the compression operation unit 21 as the results of the execution of a compression operation for second write data, as a size that requires five storage spaces. Accordingly, the control operation unit 23 may select five selection storage spaces PB<0:4>, from among the plurality of storage spaces PB<0:11>.

Furthermore, when dividing a storage region of the first memory device 150 or the second memory device 144 into the plurality of storage spaces PB<0:11>, the control operation unit 23 may set each of the plurality of storage spaces PB<0:11> to have a first space size. That is, the control operation unit 23 may set each of the plurality of storage spaces PB<0:11> to have the same size, which is a first space size. In such a case, the control operation unit 23 may predict the size of compression data based on the size of write data, may determine the value of N on the basis of the predicted size, and may select N selection storage spaces from among the plurality of storage spaces PB<0:11>.

According to an embodiment, the control operation unit 23 may determine the value of N by rounding up a decimal number value, which results from an operation of dividing the size of the predicted compression data by the size of write data, and use the value of N to set the first space size. For example, if the result of the operation of dividing the size of the compression data predicted based on the size of the write data by the first space size is 4.3, then the control operation unit 23 may set the value of N to 5 after rounding up a decimal number value of 4.3. In this example, each of the five selection storage spaces may have the same first space size.

Furthermore, when dividing a storage region of the first memory device 150 or the second memory device 144 into the plurality of storage spaces PB<0:11>, the control operation unit 23 may set a first storage space, that is, some of the plurality of storage spaces PB<0:11>, to have a second space size, and may set a second storage space, that is, the remainder of the plurality of storage spaces PB<0:11>, to have a third space size that is relatively smaller than the second space size. That is, the control operation unit 23 may set each of the plurality of storage spaces PB<0:11> to have any one of the second space size (an L storage space) and the third space size (an M storage space), that is, at least two types of sizes. In such a case, the control operation unit 23 may predict the size of compression data based on the size of write data, may determine the values of L and M and the value of N, obtained by adding the values of L and M on the basis of the predicted size. The control operation unit 23 may select L first storage spaces and M second storage spaces, from among the plurality of storage spaces PB<0:11>, to total N selection storage spaces. In this case, L may be a natural number that is equal to or smaller than N and equal to or greater than 1, and M may be an integer equal to or greater than 0.

According to an embodiment, the control operation unit 23 may determine the value of L by rounding down a decimal number value checked as the result of an operation of dividing the size of compression data, which is predicted based on the size of write data, by the second space size. The control operation unit 23 may determine the value of M by rounding up a decimal number value checked as the result of an operation of dividing a size, which is obtained by subtracting L second space sizes from the predicted size of compression data, by the third space size. Then, the control operation unit 23 may determine the value of N by adding the values of L and M. For example, if the result of an operation of dividing the predicted size of compression data by the second space size is 1.3, then the control operation unit 23 may set the value of L to 1 by rounding down a decimal number value from 1.3. Furthermore, if the result of an operation of dividing a size, which is obtained by subtracting L second space sizes from the predicted size of compression data, by the third space size is 1.7, then the control operation unit 23 may set the value of M to 2 by rounding up the decimal number value of 1.7. Furthermore, the control operation unit 23 may determine the value of N by adding the value of L and the value of M. For example, the control operation unit may set the value of N to 3 by adding the value of L set to 1 and the value of M set to 2. That is, three selection storage spaces may include one first storage space having the second space size and two second storage spaces having the third space size.

Furthermore, after the control operation unit 23 starts a compression operation for write data in the compression operation unit 21, at a first timing at which the execution rate of the compression operation reaches a first execution rate, when a first sum size of the size of first data on which compression has been performed, and the size of second data on which compression has not been performed, is equal to or smaller than a storage size corresponding to (N−K+1) selection storage spaces, the control operation unit 23 may control the compression operation unit 21 to stop the compression operation and then store the first and second data in the (N−K+1) selection storage spaces. In this case, N may be a natural number equal to or greater than 1, and K may be a natural number that is equal to or smaller than N and equal to or greater than 1.

The first data may include part of the write data that has been compressed by the compression operation performed at a first execution rate. That is, the first data may be some of compression data that are generated as the compression operation is completed. Furthermore, the second data may be the remainder of the write data except for the write data that has been compressed by the compression operation performed at the first execution rate (i.e., some of the compression data). Accordingly, storing the first and second data in the (N−K+1) selection storage spaces may mean that some of the stored write data are compressed and the remainder of the write data is stored in the (N−K+1) selection storage spaces without being compressed.

In other words, predicting, by the control operation unit 23, the value of N, that is, the number of selection storage spaces for storing compression data, based on the size of write data may mean that after a compression operation is completed, up to N selection storage spaces are used to store the compressed data.

Furthermore, when the first sum size is equal to or smaller than a storage size corresponding to the (N−K+1) selection storage spaces at the first timing, at which the execution rate of the compression operation reaches the first execution rate after the compression operation is started, then only N selection storage spaces or less (e.g., N−(K+1), because K is a natural number that is equal to or smaller than N and equal to or greater than 1) are used to store the first and second data at the first timing, even though the compression operation has not been completed.

That is, if the first sum size is equal to or smaller than a storage size corresponding to the (N−K+1) selection storage spaces at the first timing, at which time the execution rate of the compression operation reaches the first execution rate after the compression operation is started, then the number of selection storage spaces (i.e., the number of selection storage spaces to be used to store the first and second data) to be used when the compression operation is no longer being performed is N selection storage spaces (i.e., the predicted number of storage spaces to be used to store the compression data) or less when the compression operation has been completed.

Accordingly, when the first sum size is equal to or smaller than a storage size corresponding to the (N−K+1) selection storage spaces at the first timing, at which time the execution rate of the compression operation reaches the first execution rate after the compression operation is started, the control operation unit 23 according to an embodiment of the present disclosure may stop the compression operation and store the first and second data in the (N−K+1) selection storage spaces. Thus, the number of storage spaces (i.e., the (N−K+1) selection storage spaces) that are used to store data can be maintained at a predicted number (e.g., N selection storage spaces) or less, and the time consumed for a compression operation can also be minimized.

According to an embodiment, when the compression operation unit 21 generates first compression data by performing a first compression operation on first write data, the control operation unit 23 may determine N selection storage spaces based on the size of the first write data. In an example, it may be assumed that N is 3.

When N is 3, the control operation unit 23 may start the generation of the first compression data by staring the first compression operation for the first write data.

Thereafter, the control operation unit 23 may check whether the execution rate of the first compression operation being performed in the compression operation unit 21 has reached a preset first execution rate in real time.

The check may determine that the execution rate of the first compression operation has reached the preset first execution rate. The control operation unit 23 may obtain a first sum size by adding the size of first data compressed by the first compression operation, from among the first write data, and the size of second data that have not yet been compressed, from among the first write data.

Thereafter, when the first sum size is the size of (3−K+1) (because it is assumed that N is 3 and K is a natural number that is equal to or smaller than N and equal to or greater than 1) selection storage spaces or less, the control operation unit 23 may stop the first compression operation and store the first and second data in the (3−K+1) selection storage spaces. Accordingly, it may be assumed that (3−K+1) is any one of values 1 to 3.

That is, when the first sum size is greater than the size of three storage spaces, the control operation unit 23 may continue to perform the first compression operation without stopping the first compression operation. Furthermore, when the first sum size is the size of three storage spaces or less, the control operation unit 23 may stop the first compression operation. When checking whether the first sum size is the size of three storage spaces or less, the control operation unit 23 may stop the first compression operation, may additionally check whether the first sum size is the size of two storage spaces or less or the size of one storage space or less, and may adjust the number of selection storage spaces in which the first and second data are stored based on the results of the check.

For example, when the first sum size is less than the size of three storage spaces and is greater than the size of two storage spaces, the control operation unit 23 may stop the first compression operation and then store the first and second data in three selection storage spaces. As another example, when the first sum size is the size of two storage spaces or less but greater than the size of one storage space, the control operation unit 23 may stop the first compression operation and then store the first and second data in two selection storage spaces. As still another example, when the first sum size is the size of one storage space or less, the control operation unit 23 may stop the first compression operation and then store the first and second data in one selection storage space.

As described above, the control operation unit 23 may store the second data, that is, the remainder of the write data that is not compressed by the first compression operation, in (N−K+1) selection storage spaces without any alteration together with the first data that was generated by performing the first compression operation on some of the write data. However, as described above, a method of storing data generated by additionally performing a second compression operation on the second data in the (N−K+1) selection storage spaces may be performed instead of a method in which the second data is stored without any changes.

Specifically, when the first sum size is equal to or smaller than a storage size corresponding to the (N−K+1) selection storage spaces, the control operation unit 23 may stop the first compression operation, may control the compression operation unit 21 to perform a second compression operation on the second data, and then may store data that are generated after the second compression operation is completed in the (N−K+1) selection storage spaces with the compressed first data. Here, the second compression operation may be relatively faster than the first compression operation, even though the second compression operation has a relatively lower compression rate than the first compression operation. For example, the first compression operation may be an operation using the zStd compression algorithm. The second compression operation may be an operation using the LZ4 compression algorithm.

As described above, the control operation unit 23 may store data generated by performing a second compression operation on the second data, that is, the remainder of the write data after excluding the write data selected as the target of the first compression operation, in the (N−K+1) selection storage spaces. The compressed second data may be stored along with the first data generated by performing the first compression operation on write data.

In another embodiment, after the compression operation unit 21 starts a compression operation on write data, when a first sum size, which is a sum of write data in the size of compressed first data and the size uncompressed second data, is greater than a storage size corresponding to the (N−K+1) selection storage spaces at a first timing at which the execution rate of the compression operation reaches a first execution rate, the control operation unit 23 may select one of the following two operations to perform.

In a first operation, when the first sum size is greater than the storage size corresponding to the (N−K+1) selection storage spaces at the first timing at which the execution rate of the compression operation being performed in the compression operation unit 21 reaches the first execution rate, the compression operation continues to be performed and is completed. Then, the control operation unit 23 may store compression data generated as the results of the first compression operation in the N selection storage spaces, the number of which was previously predicted.

In a second operation, when the first sum size is greater than the storage size corresponding to the (N−K+1) selection storage spaces at the first timing at which the execution rate of the compression operation being performed in the compression operation unit 21 reaches the first execution rate, the compression operation continues until a second timing at which the execution rate of the compression operation reaches a second execution rate. At the second timing, a second sum size includes the size of third data on which compression has been performed from among the write data and the size of fourth data on which compression has not been performed from among the write data, may be equal to or smaller than the storage size corresponding to the (N−K+1) selection storage spaces, as a result of continued compression operations. Therefore, at the second timing the control operation unit 23 may control the compression operation unit 21 to stop the compression operation and store the third and fourth data in the (N−K+1) selection storage spaces, where N may be a natural number equal to or greater than 1, and K may be a natural number that is equal to or smaller than N and equal to or greater than 1.

In an embodiment, the third data may be data compressed by the first compression operation performed on some of the write data until at least the second timing. That is, the third data may include a relatively greater amount of compressed data than the first data. Furthermore, the fourth data may be the remainder of write data except for the write data that was compressed at the end of the first compression operation. Accordingly, storing the third and fourth data in the (N−K+1) selection storage spaces may mean that some of the write data is compressed and the remainder of the write data is stored in the (N−K+1) selection storage spaces in the state in which the remainder has not been compressed.

The second operation is described more specifically as follows.

First, predicting, by the control operation unit 23, the value of N, that is, the number of selection storage spaces for storing compression data based on the size of write data may mean that after a compression operation is completed, up to N selection storage spaces are used to store the compressed data.

Furthermore, when the second sum size is equal to or smaller than the storage size corresponding to the (N−K+1) selection storage spaces at the second timing, at which the execution rate of the compression operation reaches a second execution rate that is higher than a first execution rate after the compression operation is started, it means that N (N−K+1, because K is a natural number that is equal to or smaller than N and equal to or greater than 1) selection storage spaces or less are used to store the third and fourth data at the second timing.

That is, when the second sum size is equal to or smaller than the storage size corresponding to the (N−K+1) selection storage spaces at the second timing at which the execution rate of the compression operation reaches the second execution rate after the compression operation, the number of selection storage spaces (i.e., the number of selection storage spaces to be used to store the third and fourth data) to be used when the compression operation is no longer performed is the number of selection storage spaces or less (i.e., the number of storage spaces to be used to store compression data) to be used in the state in which the compression operation has been completed.

Accordingly, when the second sum size is equal to or smaller than the storage size corresponding to the (N−K+1) selection storage spaces at the second timing at which the execution rate of the compression operation reaches the second execution rate after the compression operation is started, the control operation unit 23 according to an embodiment of the present disclosure may stop the compression operation and store the third and fourth data in the (N−K+1) selection storage spaces. Accordingly, it is possible to maintain the number of storage spaces (the (N−K+1) selection storage spaces) that are used to store data at a predicted number (e.g., N selection storage spaces) or less and also to minimize the time taken for a compression operation.

According to an embodiment, the compression operation unit 21 may generate second compression data by performing a first compression operation on second write data. Here, the control operation unit 23 may determine N selection storage spaces based on the size of the second write data. For example, it may be assumed that N is 5.

Assuming that N is 5, the control operation unit 23 may start the generation of the second compression data by starting the first compression operation for the second write data.

Thereafter, the control operation unit 23 may check whether the execution rate of the first compression operation being performed in the compression operation unit 21 has reached a preset first execution rate in real time.

Based on the results of the check, at a first timing at which the execution rate of the first compression operation on the second write data reaches the first execution rate, the control operation unit 23 may calculate a first sum size including the size of first data compressed by the first compression operation and the size of second data that have not yet been compressed.

Thereafter, if the first sum size is greater than (5−K+1) (where it is assumed that N is 5) selection storage spaces, then the control operation unit 23 may continue to perform the first compression operation without stopping.

Thereafter, the control operation unit 23 may check whether the execution rate of the first compression operation being performed in the compression operation unit 21 has reached a preset second execution rate in real time.

At a second timing at which the execution rate of the first compression operation reaches the second execution rate based on the results of the check, the control operation unit 23 may calculate a second sum size, which includes the size of third data compressed by the first compression operation, from among the second write data, and the size of fourth data, which has not yet been compressed, from among the second write data.

Thereafter, when the second sum size is the size of (5−K+1) (where is assumed that N is 5) selection storage spaces or less, the control operation unit 23 may stop the first compression operation and store the third and fourth data in the (5−K+1) selection storage spaces, where K may be a natural number that is equal to or smaller than N and equal to or greater than 1. Accordingly, it may be assumed that (5−K+1) is any one of values 1 to 5.

That is, when the second sum size is greater than the size of five storage spaces, the control operation unit 23 may continue to perform the first compression operation without stopping. When the second sum size is the size of five storage spaces or less, however, the control operation unit 23 may stop the first compression operation. When a check is performed to determine if the second sum size is the size of five storage spaces or less, the control operation unit 23 may additionally check whether the second sum size is the size of four storage spaces or less, whether the second sum size is the size of three storage spaces or less, whether the second sum size is the size of two storage spaces or less, and whether the second sum size is the size of one storage space or less. The control operation unit 23 may adjust the number of selection storage spaces in which the third and fourth data are stored based on the results of the checks.

For example, when the second sum size is the size of five storage spaces or less but greater than the size of four storage spaces, the control operation unit 23 may stop the first compression operation and then store the third and fourth data in the five selection storage spaces. As another example, when the second sum size is the size of three storage spaces or less but greater than the size of two storage spaces, the control operation unit 23 may stop the first compression operation and then store the third and fourth data in the three selection storage spaces.

Furthermore, after the compression operation for the second write data is started in the compression operation unit 21, when the second sum size, including the size of the third data on which compression has been performed and the size of the fourth data on which compression has not been performed, is greater than the storage size corresponding to the (N−K+1) selection storage spaces at the second timing, which is when the execution rate of the compression operation reaches the second execution rate, the control operation unit 23 may complete the first compression operation by continuing to perform the first compression operation, and may store compression data generated as the results of the first compression operation in the N selection storage spaces that have been previously predicted.

That is, when the first sum size of the sizes of the first and second data is greater than the storage size corresponding to the (N−K+1) selection storage spaces at the first timing, the control operation unit 23 may check whether the second sum size of the sizes of the third and fourth data is greater than the storage size corresponding to the (N−K+1) selection storage spaces at the second timing. When the second sum size is greater than the storage size corresponding to the (N−K+1) selection storage spaces at the second timing based on the results of the check, the control operation unit 23 may complete the first compression operation by continuously performing the first compression operation at the second rate on the second write data, and may then store compression data generated as the results of the first compression operation in the N selection storage spaces that have been previously predicted.

For reference, the above description has described an embodiment in which a determination is made as to whether to stop a compression operation at a first timing when the execution rate of the compression operation reaches a first execution rate, after which time the compression operation is not stopped and proceeds to completion. An embodiment is also described in which, when a compression operation is not stopped at first timing, the compression operation continues to be performed and a second determination is made as to whether to stop the compression operation at a second timing, when the execution rate of the compression operation reaches a second execution rate. That is, the above description includes an embodiment in which whether to stop a compression operation is checked once and an embodiment in which the check is performed twice. In other embodiments contemplated by the disclosure, however, checks for whether to stop a compression operation may be performed more than twice.

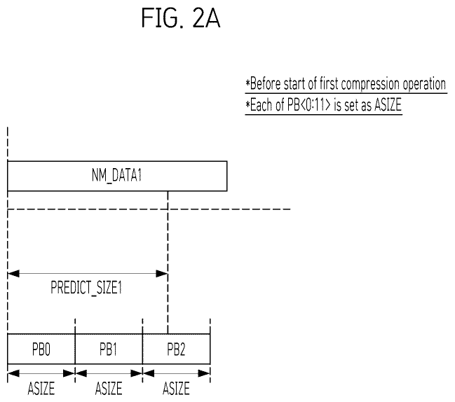

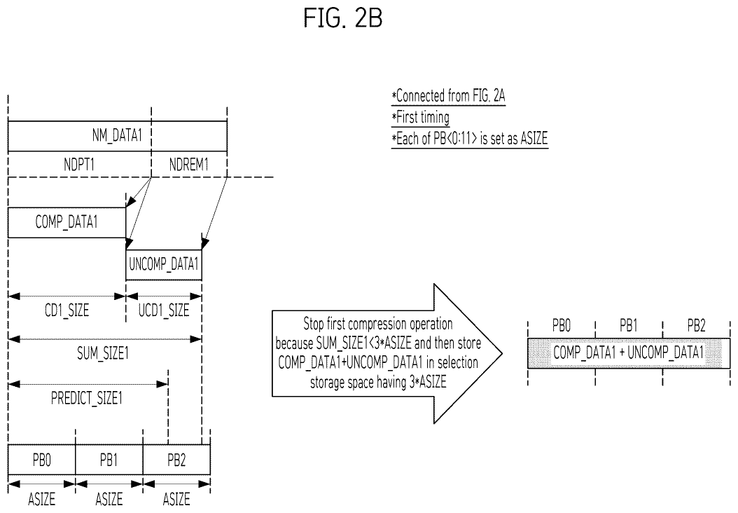

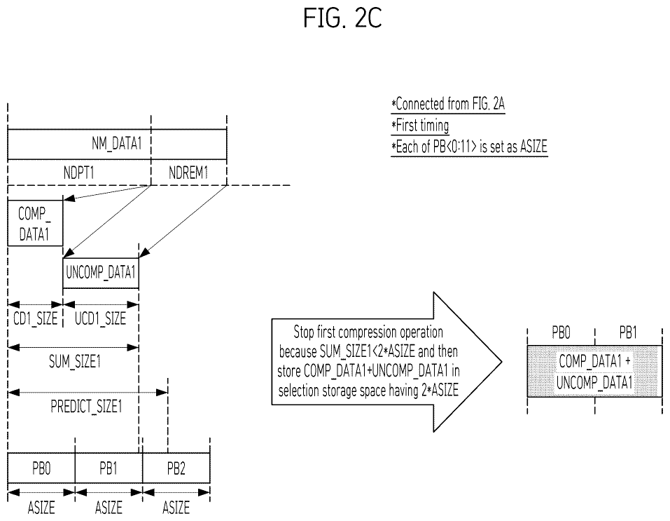

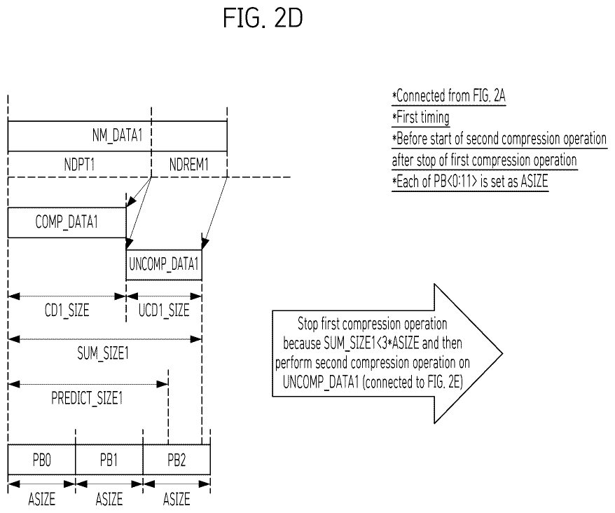

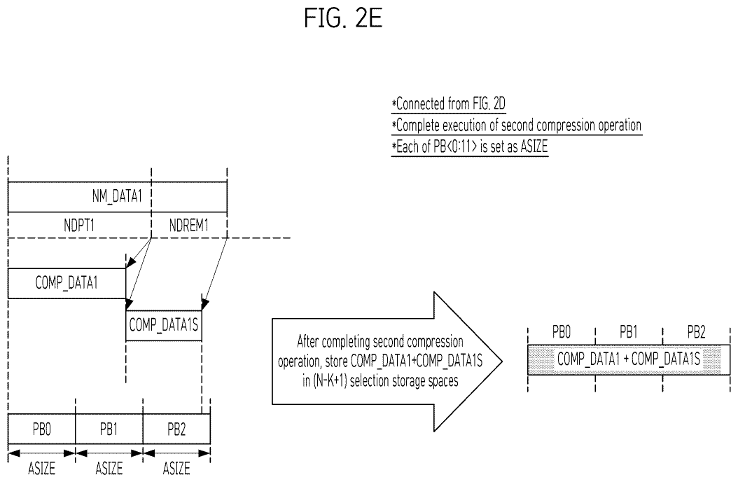

FIGS. 2A to 2E are diagrams illustrating an example of an operation of compressing and storing, by a storage device, write data in an internal memory device according to embodiments of the present disclosure.

From FIGS. 2A to 2E, an example of an operation of a storage device 110 compressing and storing first write data NM_DATA1 in a first memory device 150 or a second memory device 144 included in the storage device 110 is illustrated.

FIG. 2A illustrates a state before a first compression operation for the first write data NM_DATA1 is started.

Specifically, a control operation unit 23 may divide a storage region within the first memory device 150 or the second memory device 144 into a plurality of storage spaces PB<0:11>. The control operation unit 23 may set each of the plurality of storage spaces PB<0:11> to have the same first space size ASIZE.

Furthermore, the control operation unit 23 may predict the size PREDICT_SIZE1 of first compression data, which is the size predicted at a time after a first compression operation is completed, based on the size of the first write data NM_DATA1. In an example, the control operation unit 23 may calculate that the result of an operation of dividing the predicted size PREDICT_SIZE1 of the first compression data by the first space size ASIZE is 2.4. Accordingly, the control operation unit 23 may determine the value of N should be 3 by rounding up the decimal number value of 2.4. That is, the control operation unit 23 may select three selection storage spaces PB<0:2>, from among the plurality of storage spaces PB<0:11>.

FIG. 2B illustrates an example of an operation of the control operation unit 23 in selecting whether to stop the first compression operation at a first timing, at which time the execution rate of the first compression operation has reached a first execution rate after the first compression operation for the first write data NM_DATA1 is started.

After a first compression operation by the compression operation unit 21 on the first write data NM_DATA1 in FIG. 2A has started, FIG. 2B illustrates a state at the first timing, at which the execution rate of the first compression operation has reached the first execution rate.

Specifically, at a first timing, when a first sum size SUM_SIZE1, of a size CD1_SIZE of first data COMP_DATA1 from among the first write data NM_DATA1 that has been compressed and a size UCD1_SIZE of second data UNCOMP_DATA1 from among the first write data NM_DATA1 that has not been compressed, is equal to or smaller than a storage size (3*ASIZE) corresponding to the three selection storage spaces PB<0:2>, the control operation unit 23 may control the compression operation unit 21 to stop the first compression operation and then store the first data COMP_DATA1 and the second data UNCOMP_DATA1 in a maximum of three selection storage spaces.

At the first timing, the control operation unit 23 may be in the state in which some NDPT1 of the first write data NM_DATA1 has been generated as the first data COMP_DATA1 by compressing the some NDPT1 through the first compression operation. That is, the first data COMP_DATA1 may be compressed data, which may be generated when the first compression operation for the first write data NM_DATA1 is completed. Furthermore, the second data UNCOMP_DATA1 may be the remainder NDREM1 of the first write data NM_DATA1, except the some NDPT1 of the first write data NM_DATA1 that was compressed by the first compression operation performed at the first execution rate.

The control operation unit 23 may check whether the first sum size SUM_SIZE1 of the size CD1_SIZE of the first data COMP_DATA1 and the size UCD1_SIZE of the second data UNCOMP_DATA1 is equal to or smaller than the storage size (3*ASIZE) corresponding to the three selection storage spaces PB<0:2>.

In FIG. 2B, the first sum size SUM_SIZE1 is smaller than the storage size (3*ASIZE) corresponding to the three selection storage spaces PB<0:2>. Furthermore, the first sum size SUM_SIZE1 is greater than a storage size (2*ASIZE) corresponding to two selection storage spaces PB<0:1>.

Accordingly, the control operation unit 23 may store the first data COMP_DATA1 and the second data UNCOMP_DATA1 in the three selection storage spaces PB<0:2>. That is, the control operation unit 23 may store the some NDPT1 of the first write data NM_DATA1 and the remainder NDREM1 of the first write data NM_DATA1 in the three selection storage spaces PB<0:2>, in the state in which the some NDPT1 of the first write data NM_DATA1 has been compressed (COMP_DATA1) and the state in which the remainder NDREM1 of the first write data NM_DATA1 has not been compressed (UNCOMP_DATA1).

FIG. 2C illustrates another example of an operation of the control operation unit 23 in selecting whether to stop the first compression operation at a first timing, at which time the execution rate of the first compression operation has reached the first execution rate after the first compression operation for the first write data NM_DATA1 is started.

After a first compression operation by the compression operation unit 21 on the first write data NM_DATA1 in FIG. 2A has started, FIG. 2C illustrates a state at the first timing, at which the execution rate of the first compression operation has reached the first execution rate.

Specifically, at a first timing, when a first sum size SUM_SIZE1, of a size CD1_SIZE of first data COMP_DATA1 from among the first write data NM_DATA1 that has been compressed and a size UCD1_SIZE of second data UNCOMP_DATA1 from among the first write data NM_DATA1 that has not been compressed, is equal to or smaller than a storage size (3*ASIZE) corresponding to the three selection storage spaces PB<0:2>, the control operation unit 23 may control the compression operation unit 21 to stop the first compression operation and then store the first data COMP_DATA1 and the second data UNCOMP_DATA1 in a maximum of the three selection storage spaces PB<0:2>.

At this first timing, the control operation unit 23 may be in the state in which some NDPT1 of the first write data NM_DATA1 has been generated as the first data COMP_DATA1 by compressing the some NDPT1 through the first compression operation. That is, the first data COMP_DATA1 may be compressed data, which is a result of completing the first compression operation is first write data NM_DATA1. Furthermore, the second data UNCOMP_DATA1 may be the remainder NDREM1 of the first write data NM_DATA1, except the some NDPT1 of the first write data NM_DATA1 that was compressed by the first compression operation performed at the first execution rate.

The control operation unit 23 may check whether the first sum size SUM_SIZE1 of the size CD1_SIZE of the first data COMP_DATA1 and the size UCD1_SIZE of the second data UNCOMP_DATA1 is equal to or smaller than the storage size (3*ASIZE) corresponding to the three selection storage spaces PB<0:2>.

In FIG. 2C, the first sum size SUM_SIZE1 is smaller than the storage size (3*ASIZE) corresponding to the three selection storage spaces PB<0:2>. Furthermore, the first sum size SUM_SIZE1 is equal to or smaller than a storage size (2*ASIZE) corresponding to two selection storage spaces PB<0:1>, but the first sum size SUM_SIZE1 is greater than the size ASIZE corresponding to one selection storage space PB<0>.

Accordingly, the control operation unit 23 may store the first data COMP_DATA1 and the second data UNCOMP_DATA1 in the two selection storage spaces PB<0:1>. That is, the control operation unit 23 may store the some NDPT1 of the first write data NM_DATA1 and the remainder NDREM1 of the first write data NM_DATA1 in the two selection storage spaces PB<0:1>, in the state in which the some NDPT1 of the first write data NM_DATA1 has been compressed (COMP_DATA1) and the state in which the remainder NDREM1 of the first write data NM_DATA1 has not been compressed (UNCOMP_DATA1). If only the two selection storage spaces PB<0:1>, among the three selection storage spaces PB<0:2>, are used to store the first data COMP_DATA1 and the second data UNCOMP_DATA1 as described above, then the control operation unit 23 may use two selection storage spaces when other write data (not illustrated) that are input after the first write data NM_DATA1 are compressed and stored.

FIGS. 2D and 2E illustrate still another example of operations of the control operation unit 23 in selecting whether to stop the first compression operation at a first timing, at which time the execution rate of the first compression operation has reached the first execution rate after the first compression operation for the first write data NM_DATA1 is started.

After a first compression operation by the compression operation unit 21 on the first write data NM_DATA1 in FIG. 2A has started, FIG. 2D illustrates a state at the first timing, at which the execution rate of the first compression operation has reached the first execution rate.

Specifically, at the first timing, referring to FIGS. 2D and 2E, when a first sum size SUM_SIZE1, including a size CD1_SIZE of first data COMP_DATA1 from among the first write data NM_DATA1 that has been compressed and a size UCD1_SIZE of second data UNCOMP_DATA1 from among the first write data NM_DATA1 that has not been compressed, is equal to or smaller than a storage size corresponding to three selection storage spaces, the control operation unit 23 may stop the first compression operation, may control the compression operation unit 21 to perform a second compression operation on the second data UNCOMP_DATA1, and may then store the first data COMP_DATA1 in the three selection storage spaces PB<0:2> along with data COMP_DATA1S, which is generated by performing the second compression operation.

At the first timing, the control operation unit 23 may be in the state in which some NDPT1 of the first write data NM_DATA1 has been generated as the first data COMP_DATA1 by compressing the some NDPT1 through the first compression operation. That is, the first data COMP_DATA1 may be compressed data, which may be generated when the first compression operation for the first write data NM_DATA1 is completed. Furthermore, the second data UNCOMP_DATA1 may be the remainder NDREM1 of the first write data NM_DATA1, except the some NDPT1 of the first write data NM_DATA1 that was compressed by the first compression operation performed at the first execution rate.

The control operation unit 23 may check whether the first sum size SUM_SIZE1 of the size CD1_SIZE of the first data COMP_DATA1 and the size UCD1_SIZE of the second data UNCOMP_DATA1 is equal to or smaller than a storage size (3*ASIZE) corresponding to the three selection storage spaces PB<0:2>.

In FIG. 2D, the first sum size SUM_SIZE1 is smaller than the storage size (3*ASIZE) corresponding to the three selection storage spaces PB<0:2> based on the results of the check, but the first sum size SUM_SIZE1 is greater than the storage size (2*ASIZE) corresponding to the two selection storage spaces PB<0:1>.

Accordingly, referring to FIG. 2E, the control operation unit 23 may store a data COMP_DATA1S generated by performing a second compression operation on the second data UNCOMP_DATA1, that is, the remainder NDREM1 of the first write data NM_DATA1, in the three selection storage spaces PB<0:2> along with the first data COMP_DATA1. The control operation unit 23 may store the some NDPT1 of the first write data NM_DATA1 and the remainder NDREM1 of the first write data NM_DATA1 in the three selection storage spaces PB<0:2>, in the state in which the NDPT1 of the first write data NM_DATA1 has been compressed (COMP_DATA1) through the first compression operation and the state in which the remainder NDREM1 of the first write data NM_DATA1 has been compressed (COMP_DATA1S) through the second compression operation.

The second compression operation may be an operation that is relatively faster than the first compression operation because the second compression operation has a relatively lower compression rate than the first compression operation. For example, the first compression operation may be an operation using the zStd compression algorithm. The second compression operation may be an operation using the LZ4 compression algorithm.

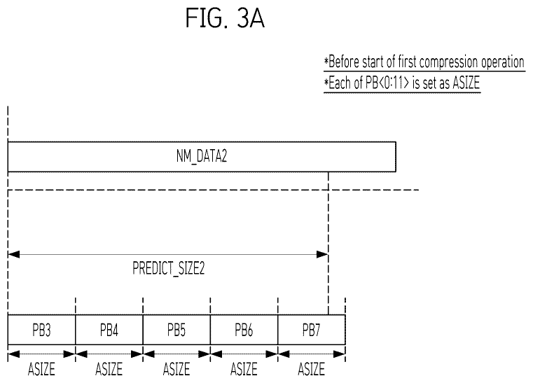

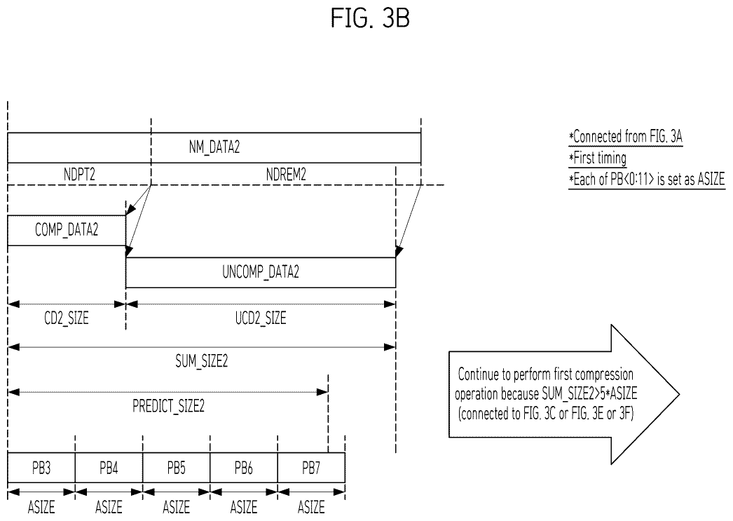

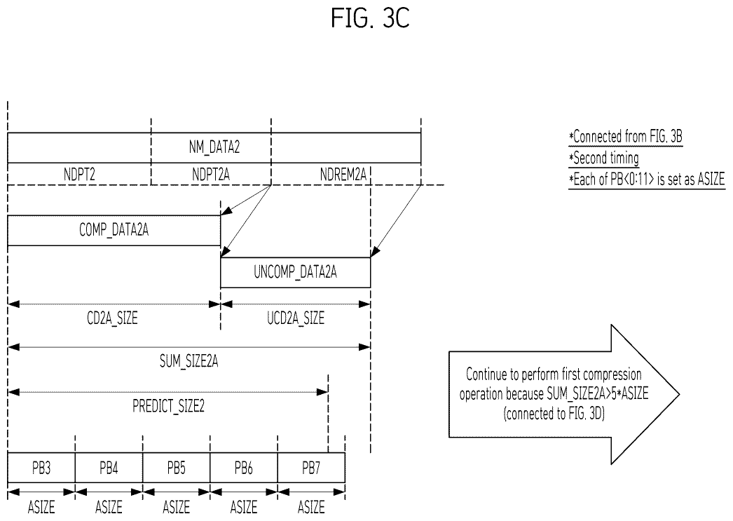

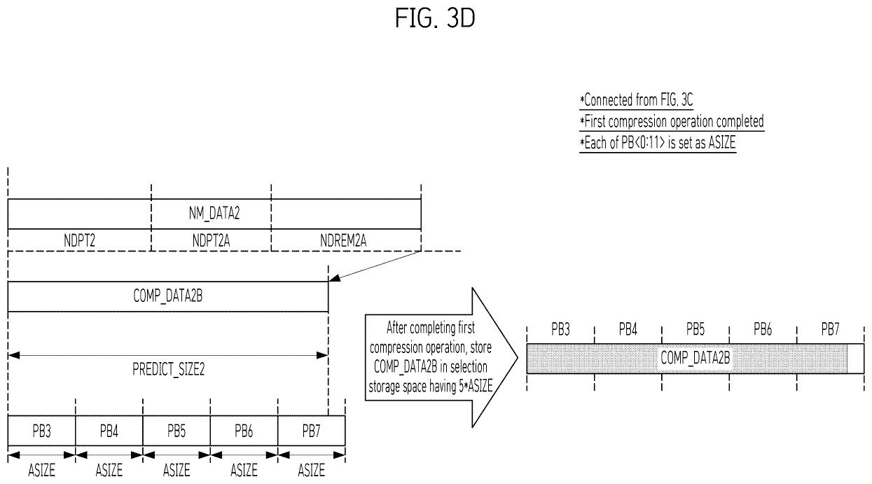

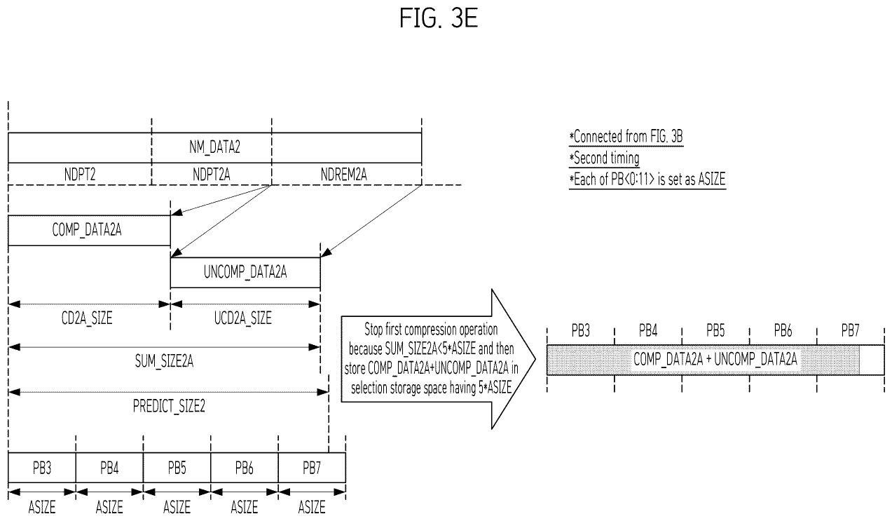

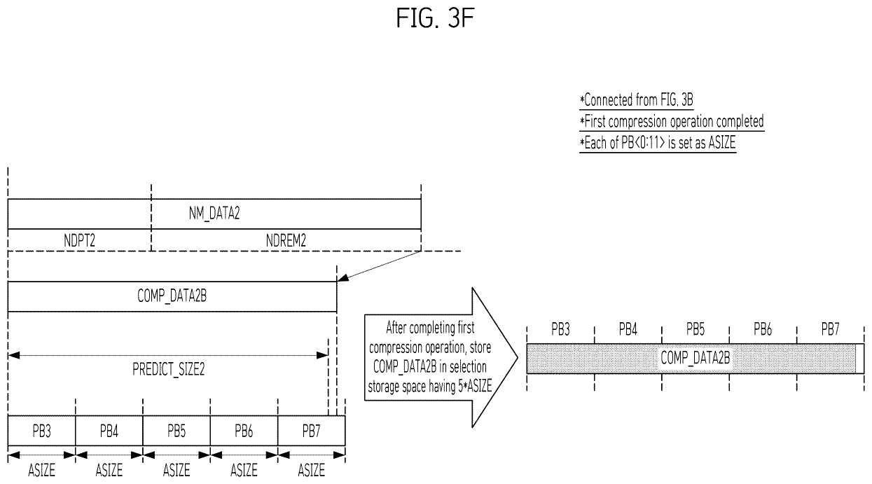

FIGS. 3A to 3F are diagrams for describing other examples of compressing and storing, by a storage device, write data in an internal memory device according to embodiments of the present disclosure.

From FIGS. 3A to 3F, a storage device 110 compresses and stores second write data NM_DATA2 in a first memory device 150 or a second memory device 144 included in the storage device 110. The second write data NM_DATA2 may be data having a greater size than the first write data NM_DATA1 illustrated in FIGS. 2A to 2E.

In FIG. 3A, a state before a first compression operation for the second write data NM_DATA2 is started may be seen.

Specifically, a control operation unit 23 may divide a storage region within the first memory device 150 or the second memory device 144 into a plurality of storage spaces PB<0:11>. The control operation unit 23 may set each of the plurality of storage spaces PB<0:11> to have the same first space size ASIZE.

Furthermore, the control operation unit 23 may predict the size PREDICT_SIZE2 of second compression data, which is the size predicted at a time after a first compression operation is completed, based on the size of the second write data NM_DATA2. Furthermore, the control operation unit 23 may check that the results of an operation of dividing the predicted size PREDICT_SIZE2 of the second compression data by the first space size ASIZE are 4.8. Accordingly, the control operation unit 23 may determine the value of N to be 5 by rounding up the decimal number value of 4.8. That is, the control operation unit 23 may select five selection storage spaces PB<3:7>, from among the plurality of storage spaces PB<0:11>, for storing data after compression.

FIG. 3B illustrates an example of an operation of the control operation unit 23 in selecting whether to stop the first compression operation at a first timing, at which time the execution rate of the first compression operation has reached a first execution rate after the first compression operation for the second write data NM_DATA2 is started.

After a first compression operation by the compression operation unit 21 on the second write data NM_DATA2 in FIG. 3A has started, FIG. 3B illustrates the first timing at which the execution rate of the first compression operation has reached the first execution rate.

Specifically, at a first timing, when a first sum size SUM_SIZE2, of a size CD2_SIZE of first data COMP_DATA2 from among the second write data NM_DATA2 has been compressed and a size UCD2_SIZE of second data UNCOMP_DATA2 from among the second write data NM_DATA2 that has not been compressed, is greater than a storage size corresponding to the five selection storage spaces, the control operation unit 23 may control the compression operation unit 21 to continue to perform the first compression operation.

At the first timing, the control operation unit 23 may be in the state in which some NDPT2 of the second write data NM_DATA2 has been generated as the first data COMP_DATA2 by compressing the some NDPT2 through the first compression operation. That is, the first data COMP_DATA2 may be compressed data, which may be generated when the first compression operation for the second write data NM_DATA2 is completed. Furthermore, the second data UNCOMP_DATA2 may be the remainder NDREM2 of the second write data NM_DATA2, except for the some NDPT2 of the second write data NM_DATA2 that was compressed by the first compression operation performed at the first execution rate.

The control operation unit 23 may check whether the first sum size SUM_SIZE2 of the size CD2_SIZE of the first data COMP_DATA2 and the size UCD2_SIZE of the second data UNCOMP_DATA2 is equal to or smaller than a storage size (5*ASIZE) corresponding to the five selection storage spaces PB<3:7>.

In FIG. 3B, the first sum size SUM_SIZE2 is greater than the storage size (5*ASIZE) corresponding to the five selection storage spaces PB<3:7> based on the results of the check.

Accordingly, the control operation unit 23 may continue to perform the first compression operation.

FIG. 3C illustrates an example of an operation of the control operation unit 23 in selecting whether to stop the first compression operation at a second timing, at which time the execution rate of the first compression operation reaches a second execution rate. At the second timing, the first compression operation has been continuously performed since the first timing, when the control operation unit 23 checked whether to stop the first compression operation, as described with reference to FIG. 3B.

That is, FIG. 3C may illustrate the second timing at which the execution rate of the first compression operation has reached the second execution rate after the first timing illustrated by FIG. 3B.

Specifically, at a second timing, when a second sum size SUM_SIZE2A, including a size CD2A_SIZE of third data COMP_DATA2A from among the second write data NM_DATA2 that has been compressed and a size UCD2A_SIZE of fourth data UNCOMP_DATA2A from among the second write data NM_DATA2 that has not been compressed, is greater than the storage size corresponding to the five selection storage space, the control operation unit 23 may control the compression operation unit 21 to continue to perform the first compression operation.

At this second timing point, the control operation unit 23 may be in the state in which some NDPT2 and NDPT2A of the second write data NM_DATA2 has been generated as the third data COMP_DATA2A by compressing the some NDPT2 and NDPT2A of the second write data NM_DATA2 through the first compression operation. That is, the third data COMP_DATA2A may include second compression data, which may be generated by the completion of the first compression operation for the second write data NM_DATA2. Furthermore, the fourth data UNCOMP_DATA2A may be the remainder NDREM2A of the second write data NM_DATA2, except for the some NDPT2 and NDPT2A of the second write data NM_DATA2 that has been compressed by the first compression operation performed at the second execution rate.

The control operation unit 23 may check whether the second sum size SUM_SIZE2A of the size CD2A_SIZE of the third data COMP_DATA2A and the size UCD2A_SIZE of the fourth data UNCOMP_DATA2A is equal to or smaller than a storage size (5*ASIZE) corresponding to the five selection storage spaces PB<3:7>.

In FIG. 3C, the second sum size SUM_SIZE2A is greater than the storage size (5*ASIZE) corresponding to the five selection storage spaces PB<3:7>based on the results of the check.

Accordingly, the control operation unit 23 may continue to perform the first compression operation.

FIG. 3D illustrates an example of an operation of the control operation unit 23 after the first compression operation, where the first compression operation continued after a determination at the first timing as described with reference to FIG. 3B, and after a check has taken place as to whether to stop the first compression operation at the second timing at which time the execution rate of the first compression operation has reached the second execution rate, as described with reference to FIG. 3C.

That is, FIG. 3D may illustrate a state when the first compression operation has been completed after the state at the second timing illustrated in FIG. 3C.

Specifically, the control operation unit 23 may store, in the five selection storage spaces PB<3:7>, second compression data COMP_DATA2B generated in accordance with the first compression operation being completed.

In FIG. 3D, the size of the second compression data COMP_DATA2B generated in accordance with the first compression operation being completed is the same as the size PREDICT_SIZE2, which is the predicted size of the second compression data that was determined before the first compression operation was started. The illustration in FIG. 3D is for convenience of description, but actually, there may be some difference between the size of the second compression data COMP_DATA2B and the size PREDICT_SIZE2 of the second compression data. The size of the second compression data COMP_DATA2B may be equal to or smaller than the storage size (5*ASIZE) corresponding to the five selection storage spaces PB<3:7>.

FIG. 3E illustrates another example of an operation of the control operation unit 23 in selecting whether to stop the first compression operation at a second timing, when the execution rate of the first compression operation reaches a second execution rate after continuing to perform the first compression operation after the control operation unit 23 has checked whether to stop the first compression operation at the first timing, as described with reference to FIG. 3B.

That is, FIG. 3E may illustrate the second timing at which the execution rate of the first compression operation has reached the second execution rate after the first timing illustrated in FIG. 3B.

Specifically, at a second timing, when the second sum size SUM_SIZE2A, including a size CD2A_SIZE of the third data COMP_DATA2A from among the second write data NM_DATA2 that have been compressed and the size UCD2A_SIZE of the fourth data UNCOMP_DATA2A from among the second write data NM_DATA2 that have not been compressed, is equal to or smaller than the storage size (5*ASIZE) corresponding to the five selection storage spaces PB<3:7>at the second timing, the control operation unit 23 may control the compression operation unit 21 to stop the first compression operation and then store the third data COMP_DATA2A and the fourth data UNCOMP_DATA2A in a maximum of the five selection storage spaces.

At the second timing point, the control operation unit 23 may be in the state in which the some NDPT2 and NDPT2A of the second write data NM_DATA2 has been generated as the third data COMP_DATA2A by compressing the some NDPT2 and NDPT2A of the second write data NM_DATA2 through the first compression operation. That is, the third data COMP_DATA2A may include second compression data, which may be generated when the first compression operation for the second write data NM_DATA2 is completed. Furthermore, the fourth data UNCOMP_DATA2A may be the remainder NDREM2A of the second write data NM_DATA2, except for the some NDPT2 and NDPT2A of the second write data NM_DATA2 that has been compressed by the first compression operation performed at the second execution rate.

The control operation unit 23 may check whether the second sum size SUM_SIZE2A of the size CD2A_SIZE of the third data COMP_DATA2A and the size UCD2A_SIZE of the fourth data UNCOMP_DATA2A is equal to or smaller than the storage size (5*ASIZE) corresponding to the five selection storage spaces PB<3:7>.

In FIG. 3E, the second sum size SUM_SIZE2A is smaller than the storage size (5*ASIZE) corresponding to the five selection storage spaces PB<3:7>based on the results of the check. Furthermore, the second sum size SUM_SIZE2A is greater than a storage size (4*ASIZE) corresponding to four selection storage spaces PB<3:6>.

Accordingly, the control operation unit 23 may store the third data COMP_DATA2A and the fourth data UNCOMP_DATA2A in the five selection storage spaces PB<3:7>. That is, the control operation unit 23 may store the some NDPT2 and NDPT2A of the second write data NM_DATA2A and the remainder NDREM2A of the second write data NM_DATA2 in the five selection storage spaces PB<3:7>, in the state in which the some NDPT2 and NDPT2A of the second write data NM_DATA2A has been compressed (COMP_DATA2A) and the state in which the remainder NDREM2A of the second write data NM_DATA2 has not been compressed (UNCOMP_DATA2A).

FIG. 3F illustrates an example of an operation of the control operation unit 23 after the first compression operation has been completed after determining to continuously perform the first compression operation at the first timing at which the execution rate of the first compression operation has reached the first execution rate, as described with reference to FIG. 3B may be seen.

That is, FIG. 3F may illustrate a time point when the first compression operation has been completed after a state at the first timing illustrated in illustrated in FIG. 3B.

Specifically, the control operation unit 23 may store, in the five selection storage spaces PB<3:7>, the second compression data COMP_DATA2B generated in accordance with the first compression operation being completed.

In FIG. 3F, the size of the second compression data COMP_DATA2B generated in accordance with the first compression operation being completed is slightly greater than the size PREDICT_SIZE2, which is the predicted size of the second compression data that was predicted before the first compression operation was started. The illustration in FIG. 3F is for convenience of description, but actually, the size of the second compression data COMP_DATA2B may be equal to or slightly smaller than the size PREDICT_SIZE2 of the second compression data. The size of the second compression data COMP_DATA2B may be equal to or smaller than the storage size (5*ASIZE) corresponding to the five selection storage spaces PB<3:7>.

For reference, in FIGS. 2B to 2E, “COMP_DATA1” has been used as the reference numeral of “first data” and “UNCOMP_DATA1” has been used as the reference numeral of “second data”. In contrast, from FIGS. 3B to 3F, it may be seen that “COMP_DATA2” has been used as the reference numeral of “first data” and “UNCOMP_DATA2” has been used as the reference numeral of “second data”. The reason why different reference numerals are used for the “first data” and the “second data” as described above is that the “first data” refer to data compressed at the first execution rate of the first compression operation and the “second data” refer to data not compressed at the first execution rate of the first compression operation. Furthermore, the reason why different reference numerals are used for the “first data” and the “second data” as described above is that FIGS. 2B to 2E are an example of a case in which the first compression operation is performed on the “first write data” and FIGS. 3B to 3F are an example of a case in which the first compression operation is performed on the “second write data”.

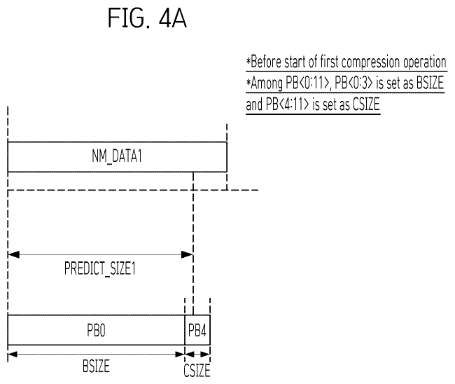

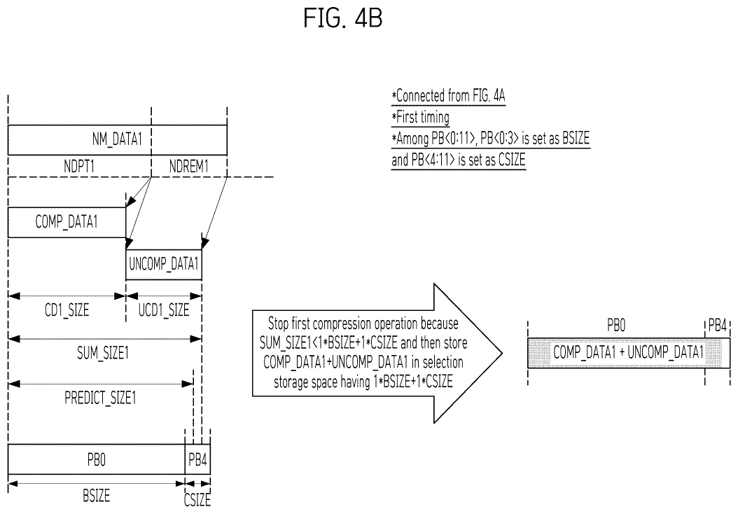

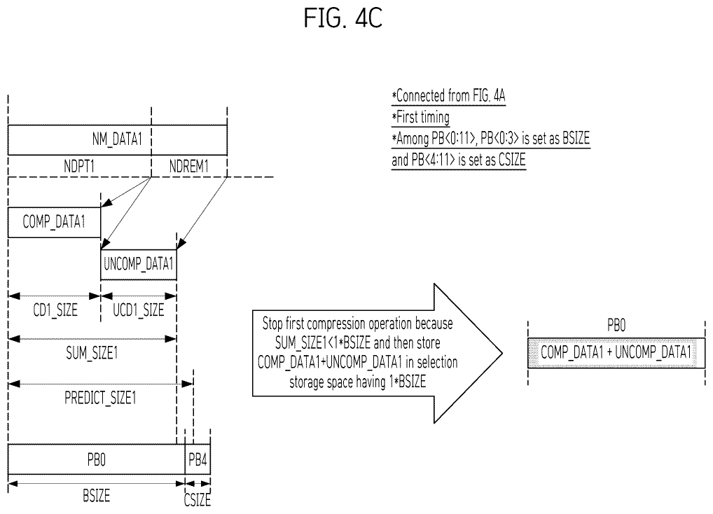

FIGS. 4A to 4C are diagrams for describing still other examples of compressing and storing, by a storage device, write data in an internal memory device according to embodiments of the present disclosure.

From FIGS. 4A to 4C, a storage device 110 compresses and stores first write data NM_DATA1 in a first memory device 150 or a second memory device 144 included in the storage device 110. That is, from FIGS. 4A to 4C, it may be seen that an operation of compressing and storing the first write data NM_DATA1 as in FIGS. 2A to 2E is described.

FIG. 4A illustrates a state before a first compression operation for the first write data NM_DATA1 is started.

Specifically, a control operation unit 23 may divide a storage region within the first memory device 150 or the second memory device 144 into a plurality of storage spaces PB<0:11>. The control operation unit 23 may set first storage spaces PB<0:3>, that is, some of the plurality of storage spaces PB<0:11>, to have a second space size BSIZE, and may set second storage spaces PB<4:11>, that is, the remainder of the plurality of storage spaces PB<0:11>, to have a third space size CSIZE, which is relatively smaller than the second space size BSIZE. That is, the control operation unit 23 may set each of the plurality of storage spaces PB<0:11>to have any one of a second space size BSIZE and a third space size CSIZE, that is, at least two types of sizes.

Furthermore, the control operation unit 23 may predict the size PREDICT_SIZE1 of first compression data, which is the size predicted at a time after a first compression operation is completed, based on the size of the first write data NM_DATA1. The control operation unit 23 may calculate that the result of an operation of dividing the predicted size PREDICT_SIZE1 of the first compression data by the second space size BSIZE as 1.2. Accordingly, the control operation unit 23 may determine the value of L to be 1 by rounding off a decimal number value from 1.2. Furthermore, the control operation unit 23 may calculate that the result of an operation of dividing a size, which is obtained by subtracting one second space size BSIZE from the predicted size PREDICT_SIZE1 of the first compression data, by the third space size CSIZE is 0.5. Accordingly, the control operation unit 23 may determine the value of M to be 1 by rounding up the decimal number value of 0.5. That is, the control operation unit 23 may determine the value of N to be 2, which is the sum of L (calculated to be 1) and M (also calculated to be 1). The control operation unit 23 may select one storage space PB0, from among the first storage spaces PB<0:3>, and one storage space PB4, from among the second storage spaces PB<4:11>, as the N selection storage spaces PB<0, 4>, where N is 2.

FIG. 4B illustrates an example of an operation of the control operation unit 23 in selecting whether to stop the first compression operation at a first timing, at which time the execution rate of the first compression operation has reached a first execution rate after the first compression operation for the first write data NM_DATA1 is started.

FIG. 4B illustrates, after the compression operation unit 21 starts a first compression operation for the first write data NM_DATA1 in FIG. 4A, the first timing at which the execution rate of the first compression operation has reached the first execution rate.

Specifically, at a first timing, when a first sum size SUM_SIZE1, of a size CD1_SIZE of first data COMP_DATA1 from among the first write data NM_DATA1 that have been compressed and a size UCD1_SIZE of second data UNCOMP_DATA1 from among the first write data NM_DATA1 that have not been compressed, is equal to or smaller than a storage size (1*BSIZE+1*CSIZE) corresponding to the two selection storage spaces PB<0, 4>, the control operation unit 23 may control the compression operation unit 21 to stop the first compression operation, and may then store the first data COMP_DATA1 and the second data UNCOMP_DATA1 in a maximum of the two selection storage spaces.

At the first timing, the control operation unit 23 may be in the state in which some NDPT1 of the first write data NM_DATA1 has been generated as the first data COMP_DATA1 by compressing the some NDPT1 through the first compression operation. That is, the first data COMP_DATA1 may be compressed data, which may be generated when the first compression operation for the first write data NM_DATA1 is completed. Furthermore, the second data UNCOMP_DATA1 may be the remainder NDREM1 of the first write data NM_DATA1, except the some NDPT1 of the first write data NM_DATA1 that was compressed by the first compression operation performed at the first execution rate.

The control operation unit 23 may check whether the first sum size SUM_SIZE1 of the size CD1_SIZE of the first data COMP_DATA1 and the size UCD1_SIZE of the second data UNCOMP_DATA1 is equal to or smaller than the storage size (1*BSIZE+1*CSIZE) corresponding to the two selection storage spaces PB<0, 4>.

In FIG. 4B, the first sum size SUM_SIZE1 is smaller than the storage size (1*BSIZE+1*CSIZE) corresponding to the two selection storage spaces PB<0, 4>based on the results of the check. Furthermore, the first sum size SUM_SIZE1 is greater than the third space size CSIZE corresponding to the second storage spaces PB<4:11>and is greater than the second space size BSIZE corresponding to the first storage spaces PB<0:3>.

Accordingly, the control operation unit 23 may store the first data COMP_DATA1 and the second data UNCOMP_DATA1 in the two selection storage spaces PB<0, 4>. That is, the control operation unit 23 may store the some NDPT1 of the first write data NM_DATA1 and the remainder NDREM1 of the first write data NM_DATA1 in the two selection storage spaces PB<0, 4>, in the state in which the some NDPT1 of the first write data NM_DATA1 has been compressed (COMP_DATA1) and the state in which the remainder NDREM1 of the first write data NM_DATA1 has not been compressed (UNCOMP_DATA1).

FIG. 4C illustrates another example of an operation of the control operation unit 23 in selecting whether to stop the first compression operation at a first timing, at which time the execution rate of the first compression operation has reached the first execution rate, after the first compression operation for the first write data NM_DATA1 was started.

FIG. 4C illustrates the first timing at which the execution rate of the first compression operation has reached the first execution rate, after the compression operation unit 21 started the first compression operation for the first write data NM_DATA1 in the state of FIG. 4A.

Specifically, at a first timing, the first sum size SUM_SIZE1, of a size CD1_SIZE of the first data COMP_DATA1 from among the first write data NM_DATA1 that have been compressed and a size UCD1_SIZE of the second data UNCOMP_DATA1 from among the first write data NM_DATA1 that have not been compressed, may be equal to or smaller than the storage size (1*BSIZE+1*CSIZE) corresponding to the two selection storage spaces PB<0, 4>. In this case, the control operation unit 23 may control the compression operation unit 21 to stop the first compression operation and then store the first data COMP_DATA1 and the second data UNCOMP_DATA1 in a maximum of the two selection storage spaces PB<0, 4>.

At the first timing, the control operation unit 23 may be in the state in which the some NDPT1 of the first write data NM_DATA1 has been generated as the first data COMP_DATA1 by compressing the some NDPT1 of the first write data NM_DATA1 through the first compression operation. That is, the first data COMP_DATA1 may be compressed data, which may be generated when the first compression operation for the first write data NM_DATA1 is completed. Furthermore, the second data UNCOMP_DATA1 may be the remainder NDREM1 of the first write data NM_DATA1, except the NDPT1 of the first write data NM_DATA1 that has been compressed through the first compression operation performed at the first execution rate.

The control operation unit 23 may check whether the first sum size SUM_SIZE1 of the size CD1_SIZE of the first data COMP_DATA1 and the size UCD1_SIZE of the second data UNCOMP_DATA1 is equal to or smaller than the storage size (1*BSIZE+1*CSIZE) corresponding to the two selection storage spaces PB<0, 4>.

In FIG. 4B, the first sum size SUM_SIZE1 is smaller than the storage size (1*BSIZE+1*CSIZE) corresponding to the two selection storage spaces (1*BSIZE+1*CSIZE) based on the results of the check. In FIG. 4C, however, the first sum size SUM_SIZE1 is greater than the third space size CSIZE corresponding to the second storage spaces PB<4:11>, but is equal to or smaller than the second space size BSIZE corresponding to the first storage spaces PB<0:3>.

Accordingly, the control operation unit 23 may store the first data COMP_DATA1 and the second data UNCOMP_DATA1 in one selection storage space PB0 as illustrated in FIG. 4C. That is, the control operation unit 23 may store the some NDPT1 of the first write data NM_DATA1 and the remainder NDREM1 of the first write data NM_DATA1 in the one selection storage space PB0, in the state in which the some NDPT1 of the first write data NM_DATA1 has been compressed (COMP_DATA1) and the state in which the remainder NDREM1 of the first write data NM_DATA1 has not been compressed (UNCOMP_DATA1). If only one selection storage space PB0, among the two selection storage spaces PB<0, 4>, is used to store the first data COMP_DATA1 and the second data UNCOMP_DATA1 as described above, the control operation unit 23 may use the remaining selection storage space PB<4:11>to compress and store other write data (not illustrated) that are input after the first write data NM_DATA1.

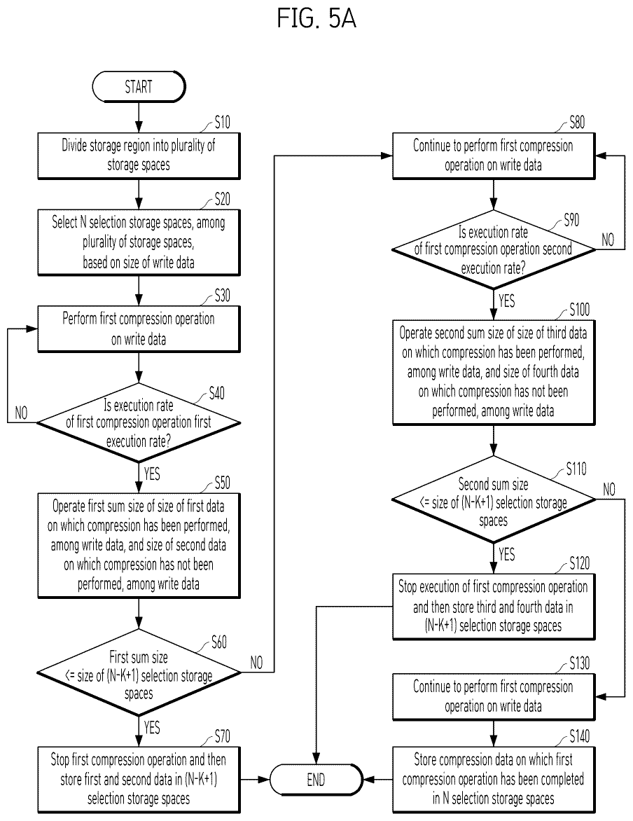

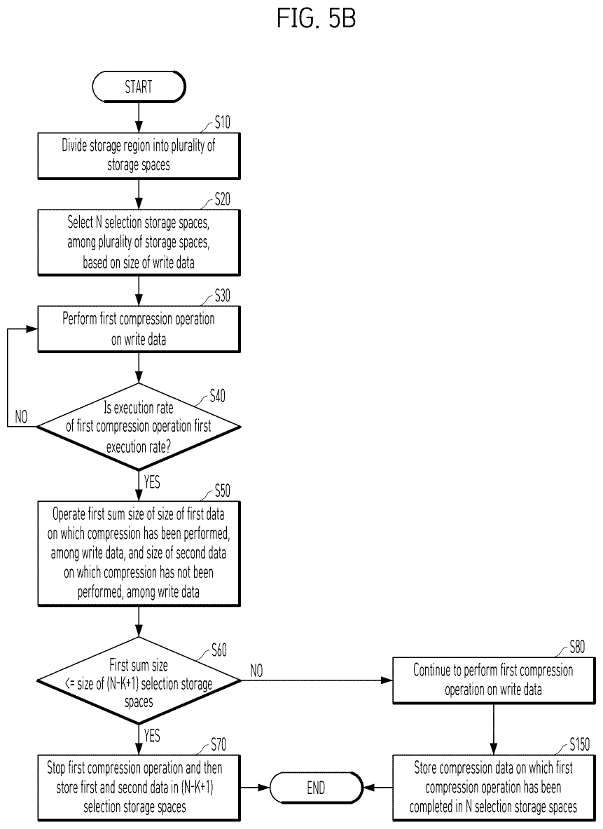

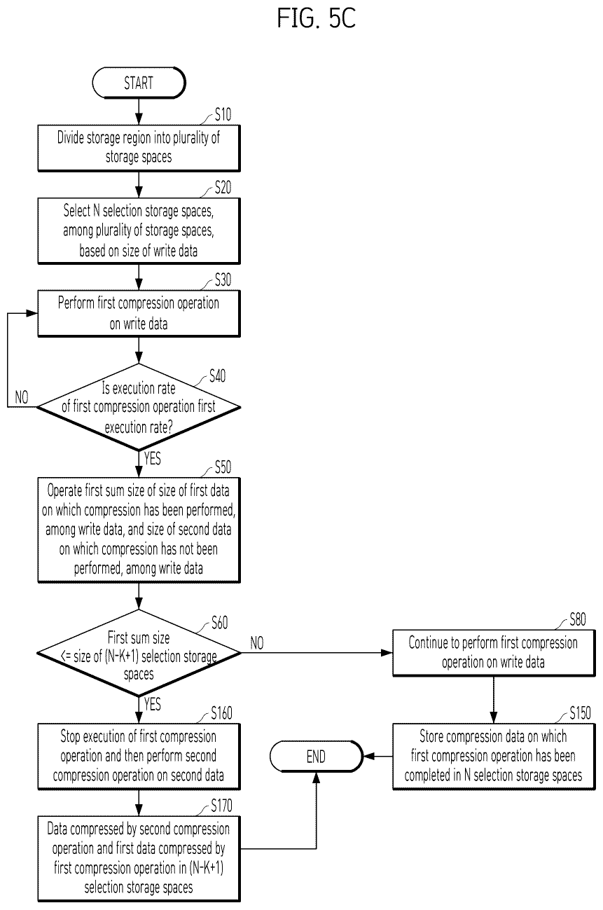

FIGS. 5A to 5C are flowcharts for describing sequences of operations of compressing and storing, by a storage device, write data in an internal memory device according to embodiments of the present disclosure.

FIGS. 5A to 5C illustrate sequences of operations of a storage device 110 according to embodiments of the present disclosure compressing and storing write data in the first memory device 150 or the second memory device 144 included in the storage device 110.

Referring to FIG. 5A, a storage region of the first memory device 150 or the second memory device 144 included in the storage device 110 may be divided into the plurality of storage spaces PB<0:11>(S10).

After S10, N selection storage spaces, among the plurality of storage spaces PB<0:11>, may be selected based on the size of input write data. N may be a natural number equal to or greater than 1. The size of compression data may be predicted based on the size of the write data. The value of N may be determined on the basis of the predicted size. Furthermore, the size of the write data and the value of N may be proportional to each other. The proportion of the size of the write data and the value of N may be vary depending on the algorithms used for compression operations or the features of the write data.

After S20, a first compression operation may be performed on the write data (S30).

The execution rate of the first compression operation being performed in S30 may be checked (S40).

If the execution rate of the first compression operation has not reached the first execution rate in S40 (NO in S40), the process may return to S30, and the first compression operation may continue to be performed.

If the execution rate of the first compression operation has reached the first execution rate in S40 (YES in S40), a first sum size of the size of first data on which compression has been performed, among the write data, and the size of second data on which compression has not been performed, among the write data, may be obtained (S50).

Whether the first sum size operated in S50 is equal to or smaller than a storage size corresponding to (N−K+1) selection storage spaces may be checked (S60).

When the first sum size is equal to or smaller than the storage size corresponding to the (N−K+1) selection storage spaces in S60 (YES in S60), the first compression operation may be stopped, and the first and second data may be stored in the (N−K+1) selection storage spaces (S70).

When the first sum size is greater than the storage size corresponding to the (N−K+1) selection storage spaces in S60 (NO in S60), the first compression operation may continue to be performed on the write data (S80).

The execution rate of the first compression operation being performed in S80 may be checked (S90).

If the execution rate of the first compression operation has not reached a second execution rate in S90 (NO in S90), the process may return to S80, and the first compression operation may continue to be performed.

If the execution rate of the first compression operation has reached the second execution rate in S90 (YES in S90), a second sum size of the size of third data on which compression has been performed, among the write data, and the size of fourth data on which compression has not been performed, among the write data, may be obtained (S100).

Whether the second sum size in S100 is equal to or smaller than the storage size corresponding to the (N−K+1) selection storage spaces may be checked (S110).

When the second sum size is equal to or smaller than the storage size corresponding to the (N−K+1) selection storage spaces in S110 (YES in S110), the first compression operation may be stopped, and the third and fourth data may be stored in the (N−K+1) selection storage spaces (S120).

When the second sum size is greater than the storage size corresponding to the (N−K+1) selection storage spaces in S110 (NO in S110), the first compression operation may continue to be performed on the write data (S130).

After S130, compression data on which the first compression operation has been completed may be generated, and the generated compression data may be stored in N selection storage spaces (S140).

Referring to FIG. 5B, the sequence from S10 to S80 is the same as the sequence described with reference to FIG. 5A.

However, FIG. 5A includes an operation S90 to S130, that is, an operation of checking whether to stop the first compression operation again when the execution rate of the first compression operation reaches the second execution rate after S80. In contrast, in FIG. 5B, after S80, compression data on which the first compression operation has been completed may be generated, and the generated compression data may be stored in N selection storage spaces (S150).

Referring to FIG. 5C, the sequence from S10 to S60 is the same as the sequence described with reference to FIG. 5A, and operations S80 and S150 when it is determined to continuously perform the first compression operation (NO in S60) is the same as that described with reference to FIG. 5B.

In FIG. 5C, however, an operation after it is determined to stop the first compression operation (YES in S60), based on the results of checking whether to stop the first compression operation because the execution rate of the first compression operation reaches the first execution rate, is different from that described with reference to FIGS. 5A and 5B.

Specifically, when it is determined to stop the first compression operation (YES in S60) based on the results of checking whether to stop the first compression operation because the execution rate of the first compression operation reaches the first execution rate, after the execution of the first compression operation is stopped, a second compression operation may be performed on the second data (S160).

Data that are generated as the second compression operation for the second data is completed in S160 and the first data generated by the first compression operation may be stored in the (N−K+1) selection storage spaces (S170). In this case, the second compression operation may be an operation that operates relatively faster than the first compression operation and that has a relatively lower compression rate than the first compression operation. For example, the first compression operation may be an operation using the zStd compression algorithm. The second compression operation may be an operation using the LZ4 compression algorithm.

It will be evident to a person having ordinary knowledge in the art to which the present disclosure pertains that the present disclosure described above is not limited by the aforementioned embodiments and the accompanying drawings and that the present disclosure may be substituted, modified, and changed in various ways without departing from the technical spirit of the present disclosure.

What is claimed is:

1. A storage device comprising:
a memory device comprising a storage region;
a compression operation unit configured to generate compression data by performing a first compression operation on write data; and
a control operation unit configured to divide the storage region into a plurality of storage spaces, configured to select N selection storage spaces from among the plurality of storage spaces, configured to control the compression operation unit, and configured to store a first data and a second data in (N−K+1) selection storage spaces when a first sum size of a size of the first data, which is a portion of the write data on which compression has been performed at a first timing, and a size of the second data, which is a portion of the write data on which compression has not been performed at the first timing, is equal to or smaller than a storage size corresponding to (N−K+1) selection storage spaces at the first timing when an execution rate of the first compression operation reaches a first execution rate,
wherein N is a natural number equal to or greater than 1, and K is a natural number that is equal to or smaller than N and equal to or greater than 1.

2. The storage device of claim 1, wherein the control operation unit
controls the compression operation unit to continue the first compression operation without storing the first data and the second data when the first sum size is greater than the storage size at the first timing, and
controls the compression operation unit to stop the first compression operation when a second sum size of a size of a third data, which is a portion of the write data on which compression has been performed at a second timing, and a size of fourth data, which is a portion of the write data on which compression has not been performed at a second timing, is equal to or smaller than the storage size at the second timing when the execution rate of the first compression operation reaches a second execution rate higher than the first execution rate and then stores the third and fourth data in the (N−K+1) selection storage spaces.

3. The storage device of claim 2, wherein the control operation unit
controls the compression operation unit to continue the first compression operation without storing the third data and the fourth data when the second sum size is greater than the storage size at the second timing and store the compression data after the first compression operation has been completed in the N selection storage spaces.

4. The storage device of claim 1, wherein the control operation unit stores the compression data on which the first compression operation has been completed in the N selection storage spaces when the first sum size is greater than the storage size at the first timing.

5. The storage device of claim 1, wherein the control operation unit
sets each of the plurality of storage spaces to have a first space size,
calculates a predicted size of the compression data based on a size of the write data, and
determines a value of N on the basis of the predicted size and the first space size.

6. The storage device of claim 5, wherein the control operation unit determines the value of N by rounding up a decimal number value that is calculated by dividing the predicted size by the first space size.

7. The storage device of claim 1, wherein the control operation unit
sets a first storage space, among the plurality of storage spaces, to have a second space size,
sets a second storage space, among the plurality of storage spaces, to have a third space size that is smaller than the second space size,
calculates a predicted size of the compression data based on a size of the write data, and
sets L first storage spaces and M second storage spaces as the N selection storage spaces by determining a value of L and a value of M on the basis of the predicted size and the value of N, which is a sum of the value of L and the value of M,
wherein L a natural number that is equal to or smaller than N and equal to or greater than 1, and M is an integer equal to or greater than 0.

8. The storage device of claim 7, wherein the control operation unit
sets the value of L by rounding down a decimal number value that is obtained by dividing the predicted size by the second space size,
sets the value of M by rounding up a decimal number value that is obtained by dividing a size, calculated by subtracting L second space sizes from the predicted size, by the third space size, and
obtains the value of N by adding the value of L and the value of M.

9. The storage device of claim 1, wherein the compression operation unit
divides the write data into a plurality of partial data,
confirms features of the plurality of partial data,
arranges an order of the plurality of partial data based on results of the confirmation, and
performs the first compression operation in the arranged order.

10. The storage device of claim 1, wherein the control operation unit
stops the first compression operation when the first sum size is equal to or smaller than the storage size and then controls the compression operation unit to perform a second compression operation on the second data, and
stores data generated by the second compression operation in the (N−K+1) selection storage spaces along with the first data after the second compression operation is completed,
wherein the second compression operation operates faster than the first compression operation and has a lower compression rate than the first compression operation.

11. An operating method of a storage device comprising a memory device comprising a storage region, the operating method comprising:
dividing the storage region into a plurality of storage spaces;
selecting N selection storage spaces, among the plurality of storage spaces, based on a size of write data;
performing a first compression operation to generate compression data from compressing the write data;
stopping the first compression operation when a first sum size of a size of a first data from among the write data on which compression has been performed at a first timing, and a size of a second data from among the write data on which compression has not been performed at the first timing, is equal to or smaller than a storage size corresponding to (N−K+1) selection storage spaces at the first timing at which time an execution rate of the first compression operation reaches a first execution rate; and
storing the first and second data in the (N−K+1) selection storage spaces when the first compression operation is stopped at the first timing,
wherein N is a natural number equal to or greater than 1, and K is a natural number that is equal to or smaller than N and equal to or greater than 1.

12. The operating method of claim 11, further comprising:
continuing to perform the first compression operation when the first sum size is greater than the storage size at the first timing;
stopping the first compression operation when a second sum size of a size of a third data from among the write data on which compression has been performed at a second timing, and a size of a fourth data on which compression has not been performed at the second timing, is equal to or smaller than the storage size at the second timing, at which time the execution rate of the first compression operation reaches a second execution rate higher than the first execution rate, and
storing the third and fourth data in the (N−K+1) selection storage spaces when the first compression operation is stopped at the second timing.

13. The operating method of claim 12, further comprising storing, in the N selection storage spaces, the compression data on which the first compression operation has been completed when the second sum size is greater than the storage size at the second timing.

14. The operating method of claim 11, further comprising storing, in the N selection storage spaces, the compression data that are generated after the first compression operation is completed when the first sum size is greater than the storage size at the first timing.

15. The operating method of claim 11, wherein:
in dividing of the storage region, each of the plurality of storage spaces is set to have a first space size, and
in selecting of the N selection storage spaces, a predicted size of the compression data is calculated based on a size of the write data, and a value of N is determined on the basis of the predicted size and the first space size.

16. The operating method of claim 15, wherein in selecting of the N selection storage spaces, the value of N is set by rounding up a decimal number value that is calculated by dividing the predicted size by the first space size.

17. The operating method of claim 11, wherein:
in dividing of the storage region, a first storage space, among the plurality of storage spaces, is set to have a second space size, and a second storage space, among the plurality of storage spaces, is set to have a third space size that is smaller than the second space size, and
in selecting of the N selection storage spaces, a predicted size of the compression data is based on a size of the write data, and L first storage spaces and M second storage spaces are selected as the N selection storage spaces by determining a value of L and a value of M, and a value of N is a sum of the value of L and the value of M on the basis of the predicted size,
wherein L is a natural number that is equal to or smaller than N and equal to or greater than 1, and M is an integer equal to or greater than 0.

18. The operating method of claim 17, wherein in the selecting of the N selection storage spaces, the value of L is set by rounding down a decimal number value that is obtained by dividing the predicted size by the second space size, the value of M is set by rounding up a decimal number value that is obtained by dividing a size, which is calculated by subtracting L second space sizes from the predicted size, by the third space size, and the value of N is determined by adding the value of L and the value of M.

19. The operating method of claim 11, wherein the performing of the first compression operation comprises:
dividing the write data into a plurality of partial data,
confirming features of the plurality of partial data,
arranging an order of the plurality of partial data based on results of the confirmation, and
performing the first compression operation in the arranged order.

20. The operating method of claim 11, further comprising:
stopping the first compression operation when the first sum size is equal to or smaller than the storage size; and
then storing data generated by performing a second compression operation on the second data in the (N−K+1) selection storage spaces along with the first data,
wherein the second compression operation is a compression operation that operates faster than the first compression operation and that has a relatively lower compression rate than the first compression operation.
